(19) United States
(12) Patent Application Publication
(10) Pub. No.: US 2024/0305514 A1
(43) Pub. Date: Sep. 12, 2024

(54) DATA SENDING METHOD AND APPARATUS

(71) Applicant: HUAWEI TECHNOLOGIES CO., LTD., Shenzhen (CN)

(72) Inventors: Jiajie TONG, Hangzhou (CN); Xianbin WANG, Hangzhou (CN); Huazi ZHANG, Hangzhou (CN); Rong LI, Boulogne Billancourt (FR); Jun WANG, Hangzhou (CN)

(73) Assignee: HUAWEI TECHNOLOGIES CO., LTD., Shenzhen (CN)

(21) Appl. No.: 18/665,859

(22) Filed: May 16, 2024

Related U.S. Application Data
(63) Continuation of application No. PCT/CN2022/126728, filed on Oct. 21, 2022.

(30) Foreign Application Priority Data
Nov. 19, 2021 (CN) 202111398517.7

(51) Int. Cl. H04L 27/34; H04L 27/38

(52) U.S. Cl. CPC H04L 27/3405; H04L 27/38

(57) ABSTRACT

This application provides a data sending method and an apparatus. The method includes: A first device sends, to a second device, first data modulated by using a first quadrature amplitude modulation codebook. The second device receives, from the first device, the first data modulated by using the first quadrature amplitude modulation codebook. When the second device fails to decode the first data modulated by using the first quadrature amplitude modulation codebook, the first device sends, to the second device, second data modulated by using a second quadrature amplitude modulation codebook. The second data is a part or all of the first data, and the first quadrature amplitude modulation codebook is different from the second quadrature amplitude modulation codebook. The second device receives, from the first device, the second data modulated by using the second quadrature amplitude modulation codebook, and jointly decodes the first data and the second data.

### CROSS-REFERENCE TO RELATED APPLICATIONS

This application is a continuation of International Application No. PCT/CN 2022/126728, filed on Oct. 21, 2022, which claims priority to Chinese Patent Application No. 202111398517.7, filed on Nov. 19, 2021. The disclosures of the aforementioned applications are hereby incorporated by reference in their entireties.

### TECHNICAL FIELD

This application relates to the communication field, and more specifically, to a data sending method and an apparatus.

### BACKGROUND

In the wireless communication field, a hybrid automatic repeat request (hybrid automatic repeat request, HARQ) is a technology formed by combining forward error correction (forward error correction, FEC) encoding and an automatic repeat request (automatic repeat request, ARQ). Main steps of the HARQ include storage, request of retransmission, and combination and demodulation. When decoding fails, a receiving end stores received data, and requests a transmitting end to retransmit data. The receiving end combines the retransmitted data and the previously received data, and then performs decoding. The method has a specific diversity gain, reduces a quantity of retransmissions, and further reduces a transmission latency.

Currently, in a soft combining (chase combine, CC) HARQ technology, completely same encoded bits are sent during data retransmission, and each time the encoded bits are sent, a same codebook is used to modulate the encoded bits. Decoding performance of the technology needs to be improved. In an incremental redundancy (incremental redundancy, IR) HARQ technology, a long encoding sequence may be used to achieve an additional long code gain, but there are many disadvantages. For example, a decoder for long code is required, which increases complexity. When the long code is limited, CC retransmission is performed. Construction complexity of a polar code (polar code, polar) IR-HARQ is excessively high, and bit mapping during encoding and decoding causes high complexity.

### SUMMARY

This application provides a data sending method and an apparatus, to improve accuracy of data receiving.

According to a first aspect, a data sending method is provided. The method may be performed by a network device or a chip or a chip system on a network device side, or may be performed by a terminal device or a chip or a chip system on a terminal device side. The method includes: A first device sends, to a second device, first data modulated by using a first quadrature amplitude modulation codebook. When the second device fails to decode the first data modulated by using the first quadrature amplitude modulation codebook, the first device sends, to the second device, second data modulated by using a second quadrature amplitude modulation codebook. The second data is a subset of the first data, and the first quadrature amplitude modulation codebook is different from the second quadrature amplitude modulation codebook. That the second data is a subset of the first data may be understood as that the second data is a part of the first data or all of the first data.

With reference to the first aspect, in some implementations of the first aspect, a minimum distance between constellation points in a two-dimensional constellation diagram formed by the first quadrature amplitude modulation codebook and the second quadrature amplitude modulation codebook is greater than or equal to a first threshold.

With reference to the first aspect, in some implementations of the first aspect, the method further includes: When the second device fails to jointly decode the first data and the second data, the first device sends, to the second device, third data modulated by using a third quadrature amplitude modulation codebook, where the third data is a subset of the first data.

With reference to the first aspect, in some implementations of the first aspect, at least one of the first quadrature amplitude modulation codebook and the second quadrature amplitude modulation codebook is different from the third quadrature amplitude modulation codebook.

With reference to the first aspect, in some implementations of the first aspect, a minimum distance between constellation points in a three-dimensional constellation diagram formed by the first quadrature amplitude modulation codebook, the second quadrature amplitude modulation codebook, and the third quadrature amplitude modulation codebook is greater than or equal to a second threshold, where the second threshold is greater than the first threshold.

With reference to the first aspect, in some implementations of the first aspect, when quadrature amplitude modulation levels of the first quadrature amplitude modulation codebook and the second quadrature amplitude modulation codebook are equal to 2, the first threshold is equal to 2\sqrt{5}Δ₂, where Δ₂ is a normalized amplitude coefficient of the first quadrature amplitude modulation codebook or the second quadrature amplitude modulation codebook; when quadrature amplitude modulation levels of the first quadrature amplitude modulation codebook and the second quadrature amplitude modulation codebook are equal to 3, the first threshold is equal to 2\sqrt{8}Δ₃, where Δ₃ is a normalized amplitude coefficient of the first quadrature amplitude modulation codebook or the second quadrature amplitude modulation codebook; or when quadrature amplitude modulation levels of the first quadrature amplitude modulation codebook and the second quadrature amplitude modulation codebook are equal to 4, the first threshold is equal to 2\sqrt{17}Δ₄, where Δ₄ is a normalized amplitude coefficient of the first quadrature amplitude modulation codebook or the second quadrature amplitude modulation codebook.

With reference to the first aspect, in some implementations of the first aspect, when the quadrature amplitude modulation levels of the first quadrature amplitude modulation codebook and the second quadrature amplitude modulation codebook are equal to 2, and a quadrature amplitude modulation level of the third quadrature amplitude modulation codebook is equal to 1, the second threshold is equal to 2\sqrt{10}Δ₂; when the quadrature amplitude modulation levels of the first quadrature amplitude modulation codebook and the second quadrature amplitude modulation codebook are equal to 3, the second threshold is equal to 2\sqrt{14}Δ₃ or 2\sqrt{71/5}Δ₃; or when the quadrature amplitude modulation levels of the first quadrature amplitude modulation codebook and the second quadrature amplitude modulation codebook are equal to 4, the second threshold is equal to 2\sqrt{33}Δ₄ or 2\sqrt{34}Δ₄.

With reference to the first aspect, in some implementations of the first aspect, the first data is data sent for a single time or data sent for a plurality of times.

According to a second aspect, a data receiving method is provided. The method may be performed by a network device or a chip or a chip system on a network device side, or may be performed by a terminal device or a chip or a chip system on a terminal device side. The method includes: A second device receives, from a first device, first data modulated by using a first quadrature amplitude modulation codebook. When the second device fails to decode the first data modulated by using the first quadrature amplitude modulation codebook, the second device receives, from the first device, second data modulated by using a second quadrature amplitude modulation codebook. The second data is a subset of the first data, and the first quadrature amplitude modulation codebook is different from the second quadrature amplitude modulation codebook. The second device jointly decodes the first data and the second data.

With reference to the second aspect, in some implementations of the second aspect, a minimum distance between constellation points in a two-dimensional constellation diagram formed by the first quadrature amplitude modulation codebook and the second quadrature amplitude modulation codebook is greater than or equal to a first threshold.

With reference to the second aspect, in some implementations of the second aspect, the method further includes: When failing to jointly decode the first data and the second data, the second device receives, from the first device, third data modulated by using a third quadrature amplitude modulation codebook, and jointly decodes the first data, the second data, and the third data, where the third data is a subset of the first data, and the third data may be the same as the second data.

With reference to the second aspect, in some implementations of the second aspect, at least one of the first quadrature amplitude modulation codebook and the second quadrature amplitude modulation codebook is different from the third quadrature amplitude modulation codebook.

With reference to the second aspect, in some implementations of the second aspect, a minimum distance between constellation points in a three-dimensional constellation diagram formed by the first quadrature amplitude modulation codebook, the second quadrature amplitude modulation codebook, and the third quadrature amplitude modulation codebook is greater than or equal to a second threshold, where the second threshold is greater than the first threshold.

With reference to the second aspect, in some implementations of the second aspect, when quadrature amplitude modulation levels of the first quadrature amplitude modulation codebook and the second quadrature amplitude modulation codebook are equal to 2, the first threshold is equal to 2\sqrt{5}Δ₂, where Δ₂ is a normalized amplitude coefficient of the first quadrature amplitude modulation codebook or the second quadrature amplitude modulation codebook; when quadrature amplitude modulation levels of the first quadrature amplitude modulation codebook and the second quadrature amplitude modulation codebook are equal to 3, the first threshold is equal to 2\sqrt{8}Δ₃, where Δ₃ is a normalized amplitude coefficient of the first quadrature amplitude modulation codebook or the second quadrature amplitude modulation codebook; or when quadrature amplitude modulation levels of the first quadrature amplitude modulation codebook and the second quadrature amplitude modulation codebook are equal to 4, the first threshold is equal to 2\sqrt{17}Δ₄, where Δ₄ is a normalized amplitude coefficient of the first quadrature amplitude modulation codebook or the second quadrature amplitude modulation codebook.

With reference to the second aspect, in some implementations of the second aspect, when the quadrature amplitude modulation levels of the first quadrature amplitude modulation codebook and the second quadrature amplitude modulation codebook are equal to 2, and a quadrature amplitude modulation level of the third quadrature amplitude modulation codebook is equal to 1, the second threshold is equal to 2\sqrt{10}Δ₂; when the quadrature amplitude modulation levels of the first quadrature amplitude modulation codebook and the second quadrature amplitude modulation codebook are equal to 3, the second threshold is equal to 2\sqrt{14}Δ₃ or 2\sqrt{71/5}Δ₃; or when the quadrature amplitude modulation levels of the first quadrature amplitude modulation codebook and the second quadrature amplitude modulation codebook are equal to 4, the second threshold is equal to 2\sqrt{33}Δ₄ or 2\sqrt{34}Δ₄.

With reference to the second aspect, in some implementations of the second aspect, the first data is data sent for a single time or data sent for a plurality of times.

According to a third aspect, a communication apparatus is provided. The apparatus may be used in the first device in the first aspect. The apparatus includes a transceiver unit, configured to send, to a second device, first data modulated by using a first quadrature amplitude modulation codebook. The transceiver unit is further configured to: when the second device fails to decode the first data modulated by using the first quadrature amplitude modulation codebook, send, to the second device, second data modulated by using a second quadrature amplitude modulation codebook. The second data is a subset of the first data, and the first quadrature amplitude modulation codebook is different from the second quadrature amplitude modulation codebook.

With reference to the third aspect, in some implementations of the third aspect, a minimum distance between constellation points in a two-dimensional constellation diagram formed by the first quadrature amplitude modulation codebook and the second quadrature amplitude modulation codebook is greater than or equal to a first threshold.

With reference to the third aspect, in some implementations of the third aspect, the transceiver unit is further configured to: when the second device fails to jointly decode the first data and the second data, send, to the second device, third data modulated by using a third quadrature amplitude modulation codebook, where the third data is a subset of the first data.

With reference to the third aspect, in some implementations of the third aspect, at least one of the first quadrature amplitude modulation codebook and the second quadrature amplitude modulation codebook is different from the third quadrature amplitude modulation codebook.

With reference to the third aspect, in some implementations of the third aspect, a minimum distance between constellation points in a three-dimensional constellation diagram formed by the first quadrature amplitude modulation codebook, the second quadrature amplitude modulation codebook, and the third quadrature amplitude modulation codebook is greater than or equal to a second threshold, where the second threshold is greater than the first threshold.

With reference to the third aspect, in some implementations of the third aspect, when quadrature amplitude modulation levels of the first quadrature amplitude modulation codebook and the second quadrature amplitude modulation codebook are equal to 2, the first threshold is equal to 2\sqrt{5}Δ₂, where Δ₂ is a normalized amplitude coefficient of the first quadrature amplitude modulation codebook or the second quadrature amplitude modulation codebook; when quadrature amplitude modulation levels of the first quadrature amplitude modulation codebook and the second quadrature amplitude modulation codebook are equal to 3, the first threshold is equal to 2\sqrt{8}Δ₃, where Δ₃ is a normalized amplitude coefficient of the first quadrature amplitude modulation codebook or the second quadrature amplitude modulation codebook; or when quadrature amplitude modulation levels of the first quadrature amplitude modulation codebook and the second quadrature amplitude modulation codebook are equal to 4, the first threshold is equal to 2\sqrt{17}Δ₄, where Δ₄ is a normalized amplitude coefficient of the first quadrature amplitude modulation codebook or the second quadrature amplitude modulation codebook.

With reference to the third aspect, in some implementations of the third aspect, when the quadrature amplitude modulation levels of the first quadrature amplitude modulation codebook and the second quadrature amplitude modulation codebook are equal to 2, and a quadrature amplitude modulation level of the third quadrature amplitude modulation codebook is equal to 1, the second threshold is equal to 2\sqrt{10}Δ₂; when the quadrature amplitude modulation levels of the first quadrature amplitude modulation codebook and the second quadrature amplitude modulation codebook are equal to 3, the second threshold is equal to 2\sqrt{14}Δ₃ or 2\sqrt{71/5}Δ₃; or when the quadrature amplitude modulation levels of the first quadrature amplitude modulation codebook and the second quadrature amplitude modulation codebook are equal to 4, the second threshold is equal to 2\sqrt{33}Δ₄ or 2\sqrt{34}Δ₄.

With reference to the third aspect, in some implementations of the third aspect, the first data is data sent for a single time or data sent for a plurality of times.

According to a fourth aspect, a communication apparatus is provided. The apparatus may be used in the second device in the second aspect. The apparatus includes a transceiver unit, configured to receive, from a first device, first data modulated by using a first quadrature amplitude modulation codebook. The transceiver unit is further configured to: when the first data modulated by using the first quadrature amplitude modulation codebook fails to be decoded, receive, from the first device, second data modulated by using a second quadrature amplitude modulation codebook. The second data is a subset of the first data, and the first quadrature amplitude modulation codebook is different from the second quadrature amplitude modulation codebook. The processing unit is configured to jointly decode the first data and the second data.

With reference to the fourth aspect, in some implementations of the fourth aspect, a minimum distance between constellation points in a two-dimensional constellation diagram formed by the first quadrature amplitude modulation codebook and the second quadrature amplitude modulation codebook is greater than or equal to a first threshold.

With reference to the fourth aspect, in some implementations of the fourth aspect, the transceiver unit is further configured to: when the first data and the second data fail to be jointly decoded, receive, from the first device, third data modulated by using a third quadrature amplitude modulation codebook, where the third data is a subset of the first data.

With reference to the fourth aspect, in some implementations of the fourth aspect, at least one of the first quadrature amplitude modulation codebook and the second quadrature amplitude modulation codebook is different from the third quadrature amplitude modulation codebook.

With reference to the fourth aspect, in some implementations of the fourth aspect, a minimum distance between constellation points in a three-dimensional constellation diagram formed by the first quadrature amplitude modulation codebook, the second quadrature amplitude modulation codebook, and the third quadrature amplitude modulation codebook is greater than or equal to a second threshold, where the second threshold is greater than the first threshold.

With reference to the fourth aspect, in some implementations of the fourth aspect, when quadrature amplitude modulation levels of the first quadrature amplitude modulation codebook and the second quadrature amplitude modulation codebook are equal to 2, the first threshold is equal to 2\sqrt{5}Δ₂, where Δ₂ is a normalized amplitude coefficient of the first quadrature amplitude modulation codebook or the second quadrature amplitude modulation codebook; when quadrature amplitude modulation levels of the first quadrature amplitude modulation codebook and the second quadrature amplitude modulation codebook are equal to 3, the first threshold is equal to 2\sqrt{8}Δ₃, where Δ₃ is a normalized amplitude coefficient of the first quadrature amplitude modulation codebook or the second quadrature amplitude modulation codebook; or when quadrature amplitude modulation levels of the first quadrature amplitude modulation codebook and the second quadrature amplitude modulation codebook are equal to 4, the first threshold is equal to 2\sqrt{17}Δ₄, where Δ₄ is a normalized amplitude coefficient of the first quadrature amplitude modulation codebook or the second quadrature amplitude modulation codebook.

With reference to the fourth aspect, in some implementations of the fourth aspect, when the quadrature amplitude modulation levels of the first quadrature amplitude modulation codebook and the second quadrature amplitude modulation codebook are equal to 2, and a quadrature amplitude modulation level of the third quadrature amplitude modulation codebook is equal to 1, the second threshold is equal to 2\sqrt{10}Δ₂; when the quadrature amplitude modulation levels of the first quadrature amplitude modulation codebook and the second quadrature amplitude modulation codebook are equal to 3, the second threshold is equal to 2\sqrt{14}Δ₃ or 2\sqrt{71/5}Δ₃; or when the quadrature amplitude modulation levels of the first quadrature amplitude modulation codebook and the second quadrature amplitude modulation codebook are equal to 4, the second threshold is equal to 2\sqrt{33}Δ₄ or 2\sqrt{34}Δ₄.

With reference to the fourth aspect, in some implementations of the fourth aspect, the first data is data sent for a single time or data sent for a plurality of times.

According to a fifth aspect, a communication device is provided, including a processor and a memory. The memory is configured to store a computer program, and the processor is configured to execute the computer program stored in the memory, to enable the communication device to perform the method in any one of the first aspect or the possible implementations of the first aspect.

According to a sixth aspect, a communication device is provided, including a processor and a memory. The memory is configured to store a computer program, and the processor is configured to execute the computer program stored in the memory, to enable the communication device to perform the method in any one of the second aspect or the possible implementations of the second aspect.

According to a seventh aspect, a communication apparatus is provided, including an input/output interface and a logic circuit. The input/output interface is configured to obtain input information and/or output information, and the logic circuit is configured to perform the method in any one of the foregoing aspects or the possible implementations of the foregoing aspects, and perform processing and/or generate the output information based on the input information.

According to an eighth aspect, a communication system is provided, including the first device, another communication device communicating with the first device, the second device, and another communication device communicating with the second device that are in the method in the first aspect or the second aspect.

According to a ninth aspect, a computer-readable storage medium is provided. The computer-readable medium stores a computer program, and when the computer program is run on a computer, the computer is enabled to perform the method in any one of the first aspect or the possible implementations of the first aspect.

According to a tenth aspect, a computer-readable storage medium is provided. The computer-readable medium stores a computer program, and when the computer program is run on a computer, the computer is enabled to perform the method in any one of the second aspect or the possible implementations of the second aspect.

According to an eleventh aspect, a computer program product including instructions is provided. When the instructions are executed by a computer, a communication apparatus is enabled to implement the method in any one of the first aspect or the possible implementations of the first aspect.

According to a twelfth aspect, a computer program product including instructions is provided. When the instructions are executed by a computer, a communication apparatus is enabled to implement the method in any one of the second aspect or the possible implementations of the second aspect.

According to the foregoing solutions, in technical solutions provided in embodiments of this application, when the second device fails to decode the first data that is sent by the first device and that is modulated by using the first quadrature amplitude modulation codebook, the first device may send, to the second device, the second data modulated by using the second quadrature amplitude modulation codebook, where the second data is the subset of the first data. The second device may jointly decode the first data and the second data. The first quadrature amplitude modulation codebook is different from the second quadrature amplitude modulation codebook, and data is retransmitted by using the different quadrature amplitude modulation codebooks, so that a bit error rate of data receiving can be reduced and accuracy of data receiving can be improved when encoding and decoding complexity is low.

### BRIEF DESCRIPTION OF DRAWINGS

FIG. 1 is a schematic diagram of a system architecture to which an embodiment of this application is applicable;

FIG. 2 is a schematic interaction flowchart of a data sending method according to an embodiment of this application;

FIG. 3 is a two-dimensional constellation diagram according to an embodiment of this application;

FIG. 4 is a three-dimensional constellation diagram according to an embodiment of this application;

FIG. 5 is another two-dimensional constellation diagram according to an embodiment of this application;

FIG. 6 is another three-dimensional constellation diagram according to an embodiment of this application;

FIG. 7 is another two-dimensional constellation diagram according to an embodiment of this application;

FIG. 8 is another three-dimensional constellation diagram according to an embodiment of this application;

FIG. 9 is another three-dimensional constellation diagram according to an embodiment of this application;

FIG. 10 to FIG. 17 are diagrams of relationships between BLERs and EsN0s corresponding to different data sending manners according to embodiments of this application;

FIG. 18 to FIG. 20 are performance comparison diagrams corresponding to different data sending manners according to embodiments of this application;

FIG. 21 is a schematic block diagram of a communication apparatus according to an embodiment of this application;

FIG. 22 is a schematic block diagram of another communication apparatus according to an embodiment of this application; and

FIG. 23 is a schematic block diagram of a communication device according to an embodiment of this application.

### DESCRIPTION OF EMBODIMENTS

The following describes technical solutions of this application with reference to the accompanying drawings.

Embodiments of this application may be applied to various communication systems, for example, a wireless local area network (wireless local area network, WLAN) system, a narrowband internet of things (narrowband internet of things, NB-IoT) system, a global system for mobile communications (global system for mobile communications, GSM), an enhanced data rate for GSM evolution (enhanced data rate for gsm evolution, EDGE) system, a wideband code division multiple access (wideband code division multiple access, WCDMA) system, a code division multiple access 2000 (code division multiple access, CDMA 2000) system, a time division-synchronous code division multiple access (time division-synchronous code division multiple access, TD-SCDMA) system, a long term evolution (long term evolution, LTE) system, satellite communication, a 5th generation (5th generation, 5G) system, or a new communication system emerging in the future.

A communication system applicable to this application includes one or more transmitting ends and one or more receiving ends. Signal transmission between the transmitting end and the receiving end may be performed through a radio wave, or may be performed through a transmission medium such as visible light, laser, infrared, or an optical fiber.

For example, one of the transmitting end and the receiving end may be a terminal device, and the other may be a network device. For example, both the transmitting end and the receiving end may be terminal devices.

The terminal device in embodiments of this application may include various handheld devices, vehicle-mounted devices, wearable devices, or computing devices that have a wireless communication function, or other processing devices connected to a wireless modem. The terminal may be a mobile station (mobile station, MS), a subscriber unit (subscriber unit), user equipment (user equipment, UE), a cellular phone (cellular phone), a smartphone (smartphone), a wireless data card, a personal digital assistant (personal digital assistant, PDA) computer, a tablet computer, a wireless modem (modem), a handheld device (handheld device), a laptop computer (laptop computer), a machine type communication (machine type communication, MTC) terminal, a wireless terminal in unmanned driving (unmanned driving), or the like. The user equipment includes vehicle user equipment.

For example, the network device may be an evolved NodeB (B (evolved NodeB, eNB)), a radio network controller (radio network controller, RNC), a NodeB (NodeB, NB), a base station controller (base station controller, BSC), a base transceiver station (base transceiver station, BTS), a home evolved NodeB (home evolved NodeB, or home NodeB, HNB), a baseband unit (baseband unit, BBU), a device that bears a base station function in device to device (device to device, D2D), an access point (access point, AP), a radio relay node, a wireless backhaul node, a transmission point (transmission point, TP), a transmission reception point (transmission reception point, TRP), or the like in a wireless fidelity (wireless fidelity, Wi-Fi) system, or may be a gNB or a transmission point (for example, a TRP or a TP) in new radio (new radio, NR), or one or a group (including a plurality of) of antenna panels of a base station in the NR, or may be a network node that forms a gNB or a transmission point, for example, a baseband unit (baseband unit, BBU) or a distributed unit (distributed unit, DU), or the network device may be a vehicle-mounted device, a wearable device, or a network device in a 5G network, or a network device or the like in a future evolved PLMN network, or a network device deployed on a satellite. This is not limited.

The network device has various product forms. For example, in a product implementation process, a BBU and a radio frequency unit (radio frequency unit, RFU) may be integrated in a same device, and the device is connected to an antenna array through a cable (for example, but not limited to a feeder). The BBU and the RFU may alternatively be disposed separately, be connected through an optical fiber, and communicate with each other through, for example, but not limited to, a common public radio frequency interface (common public radio interface, CPRI) protocol. In this case, the RFU is usually referred to as a remote radio unit (remote radio unit, RRU), which is connected to the antenna array through a cable. In addition, the RRU may alternatively be integrated with the antenna array. For example, this structure is used in an active antenna unit (active antenna unit, AAU) product in a current market.

In addition, the BBU may be further divided into a plurality of parts. For example, the BBU may be further divided into a central unit (central unit, CU) and a distributed unit (distributed unit, DU) based on real-time performance of a processed service. The CU is responsible for processing a non-real-time protocol and service, and the DU is responsible for processing a physical layer protocol and a real-time service. Further, some physical layer functions may be separated from the BBU or the DU and integrated into an AAU.

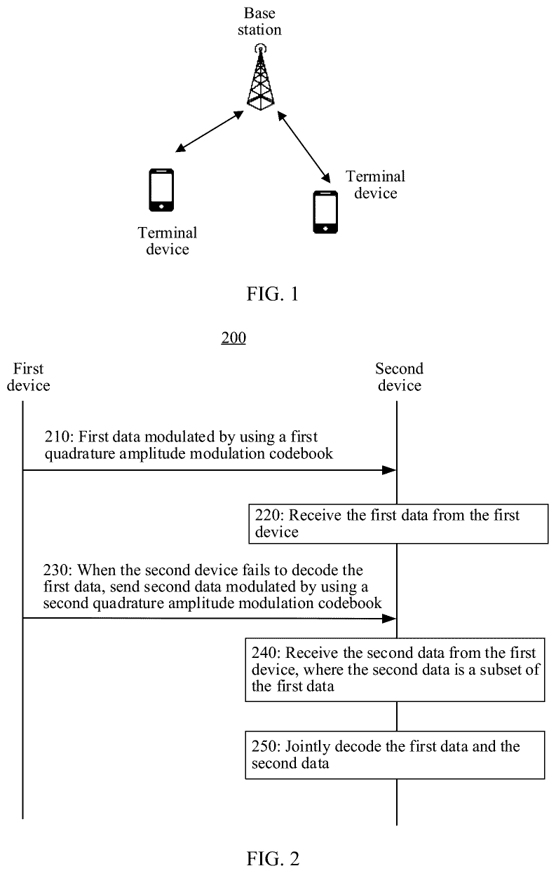

FIG. 1 is a schematic diagram of a system architecture to which an embodiment of this application is applicable. A system includes a base station and a terminal device. The base station transmits downlink data to the terminal device, encoding is performed on the downlink data through channel encoding, and data obtained through the channel encoding is transmitted to the terminal device after constellation modulation. The terminal device transmits uplink data to the base station, encoding may also be performed on the uplink data through channel encoding, and encoded data is transmitted to the base station after constellation modulation. An application scenario of embodiments of this application may be data retransmission between the base station and the terminal device.

In the wireless communication field, a hybrid automatic repeat request (hybrid automatic repeat request, HARQ) is a technology formed by combining forward error correction (forward error correction, FEC) encoding and an automatic repeat request (automatic repeat request, ARQ).

Main steps of the HARQ include storage, request of retransmission, and combination and demodulation. When decoding fails, a receiving end stores received data, and requests a transmitting end to retransmit data. The receiving end combines the retransmitted data and the previously received data, and then performs decoding. The method has a specific diversity gain, reduces a quantity of retransmissions, and further reduces a transmission latency.

The HARQ combines the FEC and the ARQ for use and is referred to as the hybrid automatic repeat request. Basic principles are as follows.

(1) A FEC technology is used, at the receiving end, to correct a part that is of all errors and that can be corrected.

(2) A data packet whose error cannot be corrected is determined through error detection. For example, the data packet whose error cannot be corrected is checked through a cyclic redundancy check (cyclic redundancy check, CRC).

(3) The transmitting end is requested to retransmit a data packet with same information, the data packet is combined with the previously received data packet, and the FEC technology continues to be used for correction.

To facilitate understanding of embodiments of this application, a retransmission technology in a conventional technology is briefly described.

### I. Soft Combining (Chase Combine, CC) Technology

When a decoded log likelihood ratio (log likelihood ratio, LLR₁) cannot pass a CRC check, where the LLR₁ is generated by demodulating data sent for the first time, a HARQ is started. Completely same encoded bits (bits) are sent for the second time, and are sent to a receiving end after same modulation. The receiving end performs independent demodulation to generate the 2^{nd} receiving LLR₂, and combines or sums the LLR₂ and the LLR₁ of the first sending to obtain an LLR_{cc}. The LLR_{cc} obtained through combination is sent to a FEC decoder for decoding, and the CRC check is performed on a decoding result. If the CRC check is passed, this transmission ends. If the CRC check is not passed or the decoding fails, a retransmission request is sent again until the decoding succeeds or a maximum quantity of retransmissions is reached.

Advantages of the CC technology lie in that a system is simple and easy to implement, and no additional complexity is added to FEC, and disadvantages lie in that decoding performance is lower than that of an incremental redundancy (incremental redundancy, IR) HARQ, and accuracy of receiving is low. Therefore, the decoding performance needs to be improved.

An IR-HARQ technology not only can enable the system to obtain a 3 dB sending energy gain, but also to obtain a long code gain of joint decoding of incrementally sent bits and original bits.

### II. Incremental Redundancy Technology

### 1. Low-Density Parity-Check (Low-Density Parity-Check, LDPC) Code Incremental Redundancy Technology

For LDPC, encoding is performed at a mother code rate, and then the first sending is performed at a code rate on which rate matching is performed and that is allowed by a system. At a receiving end, received information is demodulated into an LLR₁ for decoding. If the decoding fails, an IR-HARQ is started, and check information that is in mother code and that is not sent during the first sending is sent to the receiving end in an incremental manner. The receiving end demodulates the received information into an LLR₂, and the LLR₂ and the LLR₁ form an LLRᵢᵣ. It should be understood that the HARQ is not the same as that of CC. An amount of data in an LLR_{cc} during the soft combining is the same as an amount of data in the LLR₁, and an amount of data in the LLRᵢᵣ is a sum of amounts of data in the LLR₂ and the LLR₁. Long code decoding is performed on the LLRᵢᵣ. If the decoding succeeds, the decoding is completed. If the decoding fails, next incremental redundancy retransmission is performed, and unsent check information continues to be sent. After all check information is sent, if the decoding does not succeed yet, a new round of retransmission may be performed, in other words, CC retransmission is performed, until the decoding succeeds or a maximum quantity of retransmissions is reached.

### 2. Polar Code (Polar Code, Polar) Incremental Redundancy Technology

Polar redundancy retransmission is an excessively complex process, because for polar code, an encoding structure is adjusted based on a code rate. A current commercial solution in which HARQ transmission is performed through a polar code data channel is used as an example. For example, in a green tooth system, if the code rate of the polar code is lower than 7/16, a CC-HARQ rather than an incremental redundancy method is used for retransmission; if the code rate is higher than 7/16, an IR-HARQ is used. In a polar IR-HARQ, a new construction that has a length twice that of initially transmitted information and that is compatible with the initially transmitted information is constructed based on original mother code, and then an encoded bit additionally added in the new construction is sent. At a receiving end, an LLR₁ of initial transmission and an LLR₂ of retransmission form a new LLRᵢᵣ for decoding. If decoding performed once by using the IR-HARQ still fails, CC retransmission is performed.

In an IR-HARQ technology, a long encoding sequence may be used to achieve an additional long code gain, but there are many disadvantages. For example, a decoder for long code is required, which increases complexity. When the long code is limited, CC retransmission is performed. Construction complexity of the polar code IR-HARQ is excessively high, and bit mapping during encoding and decoding causes high complexity.

HARQ is a key technology for data transmission in the wireless communication field. The CC-HARQ and the IR-HARQ are always two most important HARQ methods. However, performance of the CC-HARQ is poorer, and complexity of the IR-HARQ is higher. Therefore, an embodiment of this application provides a data sending method. Encoding and decoding complexity of the method is low, and accuracy of data receiving can be improved.

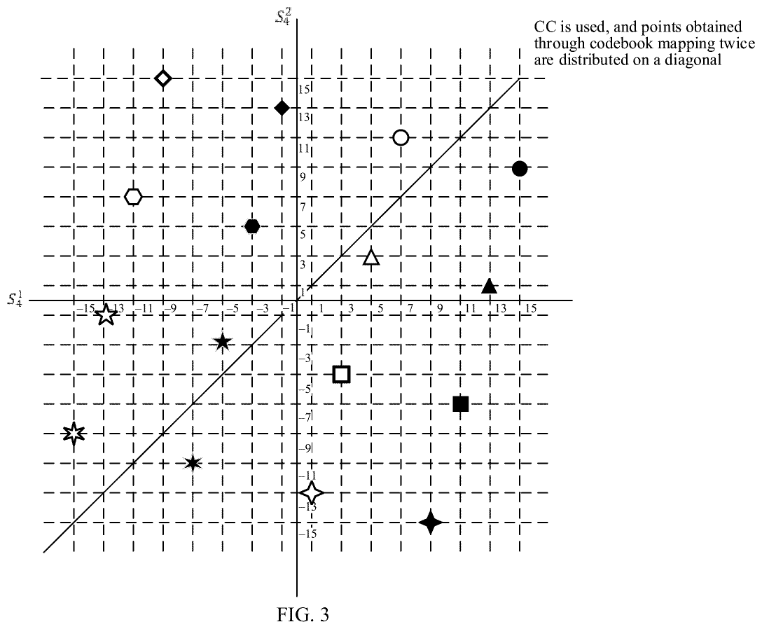

FIG. 2 is a schematic interaction flowchart of a data sending method 200 according to this embodiment of this application. In embodiments of this application, a first device may be a base station, and a second device may be a terminal device; or the first device may be a terminal device, and the second device may be a base station; or both the first device and the second device are base stations; or both the first device and the second device are terminal devices. This is not specifically limited in this application.

210: The first device sends, to the second device, first data modulated by using a first quadrature amplitude modulation (quadrature amplitude modulation, QAM) codebook, where the first data is all encoded data that needs to be sent. It should be understood that the data obtained by modulating first data may be referred to as “modulated first data”, and the first data is unmodulated data.

Optionally, the first data is data sent for a single time or data sent for a plurality of times, and the first data may further be data obtained through a plurality of times of encoding. Specifically, the first device may send, to the second device for a plurality of times, the first data modulated by using the first quadrature amplitude modulation codebook. Alternatively, the first device may send, to the second device through a plurality of times of sending, the first data modulated by using the first quadrature amplitude modulation codebook. In other words, the first device may send a part of the first data to the second device each time, until all of the first data is sent.

For example, the first data is the data sent for the plurality of times. The first device may send, to the second device for a plurality of times by using a CC technology, the first data modulated by using the first quadrature amplitude modulation codebook. Alternatively, the first device may send, to the second device by using an LDPC incremental redundancy technology, a part of the first data modulated by using the first quadrature amplitude modulation codebook each time, until all of the first data is sent.

For example, the first data is the data sent for the plurality of times, and the first data is the data obtained through the plurality of times of encoding. The first device may send, to the second device by using a polar incremental redundancy technology, the first data modulated by using the first quadrature amplitude modulation codebook.

220: The second device receives, from the first device, the first data modulated by using the first quadrature amplitude modulation codebook, and demodulates and decodes the first data. When the second device fails to decode the first data modulated by using the first quadrature amplitude modulation codebook, the second device may feed back a negative acknowledgement (negative acknowledgement, NACK) message or another message to the first device, to indicate that the decoding fails. When the second device successfully decodes the first data modulated by using the first quadrature amplitude modulation codebook, the second device may feed back an acknowledgement (acknowledgement or positive acknowledgement) message to the first device, to indicate that the decoding succeeds.

230: When the first device determines that the second device fails to decode the first data modulated by using the first quadrature amplitude modulation codebook, the first device sends, to the second device, second data modulated by using a second quadrature amplitude modulation codebook. The second data is a subset of the first data. In other words, the second data may be a part of the first data, or the second data may be all of the first data. The first quadrature amplitude modulation codebook is different from the second quadrature amplitude modulation codebook, but QAM levels of the first quadrature amplitude modulation codebook and the second quadrature amplitude modulation codebook are the same. It should be understood that a quadrature amplitude modulation codebook may be understood as a mapping manner, and different quadrature amplitude modulation codebooks may form a constellation diagram. If the first quadrature amplitude modulation codebook is the same as the second quadrature amplitude modulation codebook, it is equivalent to CC retransmission, and receiving accuracy of the second device is low.

Optionally, that a minimum distance between constellation points in a two-dimensional constellation diagram formed by the first quadrature amplitude modulation codebook and the second quadrature amplitude modulation codebook is greater than or equal to a first threshold may be understood as that a distance between adjacent closest constellation points in the two-dimensional constellation diagram formed by the first quadrature amplitude modulation codebook and the second quadrature amplitude modulation codebook is greater than or equal to the first threshold. The QAM level of the quadrature amplitude modulation codebook may be equal to 2, may be equal to 3, may be equal to 4, or may be equal to 5. This is not specifically limited in this application.

Specifically, the first threshold is determined based on a normalized amplitude coefficient of the first quadrature amplitude modulation codebook and a normalized amplitude coefficient of the second quadrature amplitude modulation codebook. The normalized amplitude coefficient of the quadrature amplitude modulation codebook may be determined according to the following formula (1).

$$Δ = \sqrt{{\sum }_{j = 0}^{{2}^{m} - 1} ( P [ j ] \times {( {S}_{m}^{i} [ j ] )}^{2} )} \qquad ( 1 )$$

m is the QAM level of the quadrature amplitude modulation codebook; i represents different quadrature amplitude modulation codebooks; j is an integer from 0 to 2^{m}−1; and P[j] is an occurrence probability of Sⁱₘ[j], where if Sⁱₘ[j] is evenly distributed, A[j]=½^{m}.

For example, when the QAM levels of the first quadrature amplitude modulation codebook and the second quadrature amplitude modulation codebook are equal to 2, and the normalized amplitude coefficient of the first quadrature amplitude modulation codebook is the same as the normalized amplitude coefficient of the second quadrature amplitude modulation codebook, the first threshold may be equal to 2\sqrt{5}Δ₂, where Δ₂ is the normalized amplitude coefficient of the first quadrature amplitude modulation codebook or the second quadrature amplitude modulation codebook.

Specifically, a method for determining Δ₂ is shown in formula (2).

$${Δ}_{2} = \sqrt{{\sum }_{j = 0}^{{2}^{2} - 1} ( P [ j ] \times {( {S}_{2}^{i} [ j ] )}^{2} )} \qquad ( 2 )$$

i represents different quadrature amplitude modulation codebooks. For example, when i is equal to 1, Δ₂ may represent the normalized amplitude coefficient of the first quadrature amplitude modulation codebook; or when i is equal to 2, Δ₂ may represent the normalized amplitude coefficient of the second quadrature amplitude modulation codebook. P[j] is an occurrence probability of Sⁱ₂[j], where if Sⁱ₂[j] is evenly distributed, P[j]=¼. It should be understood that, when Sⁱ₂[j] is evenly distributed, it is determined that the first threshold is equal to 2\sqrt{5}Δ₂; or when Sⁱ₂[j] is not evenly distributed, the first threshold may alternatively be another value. For example, assuming that the normalized amplitude coefficient of the first quadrature amplitude modulation codebook is Δ¹₂, and the normalized amplitude coefficient of the second quadrature amplitude modulation codebook is Δ²₂, the first threshold may be equal to min(2×\sqrt{4×(Δ¹₂)²+(Δ²₂)²}, 2×\sqrt{(Δ¹₂)²+4×(Δ²₂)²}), where a min function represents that a smaller one of the two values is used.

For example, when the QAM levels of the first quadrature amplitude modulation codebook and the second quadrature amplitude modulation codebook are equal to 3, and the normalized amplitude coefficient of the first quadrature amplitude modulation codebook is the same as the normalized amplitude coefficient of the second quadrature amplitude modulation codebook, the first threshold may be equal to 2\sqrt{8}Δ₃, where Δ₃ is the normalized amplitude coefficient of the first quadrature amplitude modulation codebook or the second quadrature amplitude modulation codebook.

Specifically, a method for determining Δ₃ is shown in formula (3).

$${Δ}_{3} = \sqrt{{\sum }_{j = 0}^{{2}^{3} - 1} ( P [ j ] \times {( {S}_{3}^{i} [ j ] )}^{2} )} \qquad ( 3 )$$

i represents different quadrature amplitude modulation codebooks. For example, when i is equal to 1, Δ₃ may represent the normalized amplitude coefficient of the first quadrature amplitude modulation codebook; or when i is equal to 2, Δ₃ may represent the normalized amplitude coefficient of the second quadrature amplitude modulation codebook. P[j] is an occurrence probability of Sⁱ₃[j], where if Sⁱ₃[j] is evenly distributed, P[j]=⅛.

It should be understood that, when Sⁱ₃[j] is evenly distributed, it is determined that the first threshold is equal to 2\sqrt{8}Δ₃; or when Sⁱ₃[j] is not evenly distributed, the first threshold may alternatively be another value. For example, assuming that the normalized amplitude coefficient of the first quadrature amplitude modulation codebook is Δ¹₃, and the normalized amplitude coefficient of the second quadrature amplitude modulation codebook is Δ¹₃, the first threshold be may equal to min(2×\sqrt{4×(Δ¹₃)²+4×(Δ²₃)²}, 2×\sqrt{9×(Δ¹₃)²+(Δ²₃)²}, 2×\sqrt{(Δ¹₃)²+9×(Δ²₃)²}), where a min function represents that a smaller one of the three values is used.

For example, when the QAM levels of the first quadrature amplitude modulation codebook and the second quadrature amplitude modulation codebook are equal to 4, and the normalized amplitude coefficient of the first quadrature amplitude modulation codebook is the same as the normalized amplitude coefficient of the second quadrature amplitude modulation codebook, the first threshold may be equal to 2\sqrt{17}Δ₄, where Δ₄ is the normalized amplitude coefficient of the first quadrature amplitude modulation codebook or the second quadrature amplitude modulation codebook.

Specifically, a method for determining Δ₄ is shown in formula (4).

$${Δ}_{4} = \sqrt{{\sum }_{j = 0}^{{2}^{4} - 1} ( P [ j ] \times {( {S}_{4}^{i} [ j ] )}^{2} )} \qquad ( 4 )$$

i represents different quadrature amplitude modulation codebooks. For example, when i is equal to 1, Δ₄ may represent the normalized amplitude coefficient of the first quadrature amplitude modulation codebook; or when i is equal to 2, Δ₄ may represent the normalized amplitude coefficient of the second quadrature amplitude modulation codebook. P[j] is an occurrence probability of Sⁱ₄[j], where if Sⁱ₄[j] is evenly distributed, P[j]= 1/16. It should be understood that, when Sⁱ₄[j] is evenly distributed, it is determined that the first threshold is equal to 2\sqrt{17}Δ₄; or when Sⁱ₄[j] is not evenly distributed, the first threshold may alternatively be another value. For example, assuming that the normalized amplitude coefficient of the first quadrature amplitude modulation codebook is 43, and the normalized amplitude coefficient of the second quadrature amplitude modulation codebook is Δ²₃, the first threshold may be equal to min(2×\sqrt{16×(Δ¹₄)²+(Δ²₄)²}, 2×\sqrt{(Δ¹₄)²+16×(Δ²₄)²}), where a min function represents that a smaller one of the two values is used.

When the QAM levels of the first quadrature amplitude modulation codebook and the second quadrature amplitude modulation codebook are equal to 5, a method for calculating the first threshold is similar to the foregoing method, and details are not described herein.

240: When the second device fails to decode the first data modulated by using the first quadrature amplitude modulation codebook, the second device receives, from the first device, the second data modulated by using the second quadrature amplitude modulation codebook.

250: The second device jointly decodes the first data and the second data. Specifically, the second device combines the first data and the second data and then decodes combined data.

Optionally, when the second device fails to jointly decode the first data modulated by using the first quadrature amplitude modulation codebook and the second data modulated by using the second quadrature amplitude modulation codebook, the first device may send, to the second device, third data modulated by using a third quadrature amplitude modulation codebook. The third data is a subset of the first data. In other words, the third data may be a part of the first data, or the third data may be all of the first data. The third data may be the same as the second data, or the third data may be different from the second data. Correspondingly, when the second device fails to jointly decode the first data modulated by using the first quadrature amplitude modulation codebook and the second data modulated by using the second quadrature amplitude modulation codebook, the second device may receive, from the first device, the third data modulated by using the third quadrature amplitude modulation codebook, and jointly decode the first data, the second data, and the third data.

At least one of the first quadrature amplitude modulation codebook and the second quadrature amplitude modulation codebook is different from the third quadrature amplitude modulation codebook. For example, the third quadrature amplitude modulation codebook is different from the first quadrature amplitude modulation codebook and the second quadrature amplitude modulation code both. For another example, the third quadrature amplitude modulation codebook is the same as the first quadrature amplitude modulation codebook, and the third quadrature amplitude modulation codebook is different from the second quadrature amplitude modulation codebook. For another example, the third quadrature amplitude modulation codebook is the same as the second quadrature amplitude modulation codebook, and the third quadrature amplitude modulation codebook is different from the first quadrature amplitude modulation codebook.

In addition, a QAM level of the third quadrature amplitude modulation codebook may be the same as or different from that of the first quadrature amplitude modulation codebook or the second quadrature amplitude modulation codebook. This is not specifically limited in this application.

Optionally, a minimum distance between constellation points in a three-dimensional constellation diagram formed by the first quadrature amplitude modulation codebook, the second quadrature amplitude modulation codebook, and the third quadrature amplitude modulation codebook is greater than or equal to a second threshold, where the second threshold is greater than the first threshold.

For example, when the quadrature amplitude modulation levels of the first quadrature amplitude modulation codebook and the second quadrature amplitude modulation codebook are equal to 2, the quadrature amplitude modulation level of the third quadrature amplitude modulation codebook is equal to 1, and the normalized amplitude coefficient of the first quadrature amplitude modulation codebook is the same as the normalized amplitude coefficient of the second quadrature amplitude modulation codebook, the second threshold may be equal to 2\sqrt{10}Δ₂

For example, when the quadrature amplitude modulation levels of the first quadrature amplitude modulation codebook, the second quadrature amplitude modulation codebook, and the third quadrature amplitude modulation codebook are equal to 3, and the normalized amplitude coefficient of the first quadrature amplitude modulation codebook is the same as the normalized amplitude coefficient of the second quadrature amplitude modulation codebook, the second threshold may be equal to 2\sqrt{14}Δ₃. When the quadrature amplitude modulation levels of the first quadrature amplitude modulation codebook and the second quadrature amplitude modulation codebook are equal to 3, the quadrature amplitude modulation level of the third quadrature amplitude modulation codebook is equal to 2, and the normalized amplitude coefficient of the first quadrature amplitude modulation codebook is the same as the normalized amplitude coefficient of the second quadrature amplitude modulation codebook, the second threshold may be equal to 2\sqrt{71/5}Δ₃.

For example, when the quadrature amplitude modulation levels of the first quadrature amplitude modulation codebook, the second quadrature amplitude modulation codebook, and the third quadrature amplitude modulation codebook are equal to 4, and the normalized amplitude coefficient of the first quadrature amplitude modulation codebook is the same as the normalized amplitude coefficient of the second quadrature amplitude modulation codebook, the second threshold may be equal to 2\sqrt{33}Δ₄. When the quadrature amplitude modulation levels of the first quadrature amplitude modulation codebook and the second quadrature amplitude modulation codebook are equal to 4, the quadrature amplitude modulation level of the third quadrature amplitude modulation codebook is equal to 2, and the normalized amplitude coefficient of the first quadrature amplitude modulation codebook is the same as the normalized amplitude coefficient of the second quadrature amplitude modulation codebook, the second threshold may be equal to 2\sqrt{34}Δ₄.

When the QAM levels of the first quadrature amplitude modulation codebook, the second quadrature amplitude modulation codebook, and the third quadrature amplitude modulation codebook are equal to 5, a method for calculating the second threshold is similar to the foregoing method, and details are not described herein.

In the technical solutions provided in embodiments of this application, when the second device fails to decode the first data that is sent by the first device and that is modulated by using the first quadrature amplitude modulation codebook, the first device may send, to the second device, the second data modulated by using the second quadrature amplitude modulation codebook, where the second data is the subset of the first data. The second device may jointly decode the first data and the second data. The first quadrature amplitude modulation codebook is different from the second quadrature amplitude modulation codebook, and data is retransmitted by using the different quadrature amplitude modulation codebooks, so that a bit error rate of data receiving can be reduced and accuracy of the data receiving can be improved when encoding and decoding complexity is low.

The following briefly describes specific implementations of embodiments of this application.

To maximize a difference between a plurality of times of transmission of a same signal, a QAM symbol is split into two channels of signal: I and Q, and each channel includes m bits (bits). For example, for QAM 16 whose QAM level is equal to 2, each channel of signal includes two bits; for QAM 64 whose QAM level is equal to 3, each channel of signal includes three bits; for QAM 256 whose QAM level is equal to 4, each channel of signal includes four bits; and for QAM 1024 whose QAM level is equal to 5, each channel of signal includes five bits.

It is assumed that to-be-sent data has a maximum mother code length of N, and has a data set A={a₀, a₁, a₂ . . . a_{K-1}} of K bits, an encoded set obtained by encoding the data set is B={b₀, b₁, b₂ . . . b_{N-1}}, and {b₀, b₁, b₂ . . . b_{N-1}} is obtained by interleaving the encoded set; based on a QAM level m, {b₀, b₁, b₂ . . . b_{N-1}} is divided into {B₀, B₁, B₂ . . . . B_{N/m-1}}, where Bᵢ={b_{i×m}, b_{i×m+1}; b_{i×m+2} . . . b_{i×m+m-1}}, i∈{0, 1, . . . , N/m−1}; m bits in B form a decimal number Cᵢ=Σⱼ₌₀^{m-1}2^{j}×b_{i×m+j} each time; and finally, the decimal number is mapped by using a quadrature amplitude modulation codebook and sending is performed, where a sending value may be equal to S^{x}ₘ[Cᵢ].

A quadrature amplitude modulation codebook combination may be represented as {S¹ₘ, S²ₘ, S³ₘ . . . S^{x}ₘ>}, where m represents the QAM level, and a superscript x represents a quadrature amplitude modulation codebook used when x^{th} data is sent, for example, first data, second data, and third data. The first data may be sent through a plurality of times of sending, and the second data may also be sent through a plurality of times of sending, but a same quadrature amplitude modulation codebook is used for all data in the x^{th} data. After the quadrature amplitude modulation codebook combination is used up, a quadrature amplitude modulation codebook used for the first sending may be reused, and the rest may be deduced by analogy.

### Implementation 1:

A QAM 256 codebook whose QAM level is equal to 4 is used as an example. In modulation by using QAM 256, a maximum of three different quadrature amplitude modulation codebooks are supported. In this case, there is a quadrature amplitude modulation codebook combination S₄={S¹₄, S²₄, S³₄}. For example,

$${S}_{4}^{1} = \{ 15 , 13 , 9 , 11 , 1 , 3 , 7 , 5 , - 15 , - 13 , - 9 , - 11 , - 1 , - 3 , - 7 , - 5 \} ,$$

$${S}_{4}^{2} = \{ 9 , 1 , - 15 , - 7 , - 13 , - 5 , 11 , 3 , - 9 , - 1 , 15 , 7 , 13 , 5 , - 11 , - 3 \} , and$$

$${S}_{4}^{3} = \{ - 7 , - 15 , 1 , 9 , - 13 , - 5 , 11 , 3 , - 9 , - 1 , 15 , 7 , - 3 , - 11 , 5 , 13 \} .$$

It is clear that the first mapping is Gray mapping, and the second and third mapping are not. Because maximum of performance of the first transmission needs to be ensured, performance of the second and third transmission cannot be guaranteed.

An example in which a data set of the first data is the foregoing A={a₀, a₁, a₂ . . . a_{K-1}} is used. A first quadrature amplitude modulation codebook may be S¹₄, and a first device may send, to a second device, first data modulated by using S¹₄. A sending value that is when Bᵢ is sent by using the first quadrature amplitude modulation codebook is equal to S¹₄[Cᵢ], where Cᵢ is a decimal number with a value of [0, 15]. For example, when Cᵢ is equal to 0, the sending value that is when Bᵢ is sent by using the first quadrature amplitude modulation codebook is equal to 15; when Cᵢ is equal to 1, the sending value that is when Bᵢ is sent by using the first quadrature amplitude modulation codebook is equal to 13; or when Cᵢ is equal to 2, the sending value that is when Bᵢ is sent by using the first quadrature amplitude modulation codebook is equal to 9.

A second quadrature amplitude modulation codebook may be S²₄. When the second device fails to decode the first data modulated by using S¹₄, the first device may send, to the second device, second data modulated by using S²₄, where the second data may be data the same as the first data, or may be a part of the first data. When the second data and the first data are the same data, a sending value that is when Bᵢ is sent by using the second quadrature amplitude modulation codebook may be equal to S²₄[Cᵢ] multiplying Δ₄.

A third quadrature amplitude modulation codebook may be S²₄. When the second device fails to jointly decode the first data modulated by using S¹₄ and the second data modulated by using S¹₄, the first device may send, to the second device, third data modulated by using S³₄, where the third data may be data the same as the first data, or may be a part of the first data, and the third data and the second data may also be same data. When the third data and the first data are the same data, a sending value that is when Bᵢ is sent by using the third quadrature amplitude modulation codebook may be equal to S³₄[Cᵢ] multiplying Δ₄. Optionally, the third quadrature amplitude modulation codebook may alternatively be S¹₄ or S²₄.

A virtual two-dimensional coordinate diagram is constructed, where a horizontal coordinate is a symbol amplitude sent for the first time, and a vertical coordinate is a symbol amplitude sent for the second time. The amplitudes sent in the two times of sending may form a constellation point in the two-dimensional constellation diagram. FIG. 3 is a two-dimensional constellation diagram according to an embodiment of this application. If a first device performs sending only once by using S¹₄, points on an X-axis are formed. Therefore, a distance between adjacent closest constellation points is equal to 2×Δ₄, where Δ₄ is a normalized amplitude coefficient of S¹₄. If sending is performed twice by using S¹₄, in other words, CC retransmission is performed, X=Y. In this case, a value of Cᵢ is of [0, 15], and a straight line in FIG. 3 is formed. Therefore, a distance between adjacent closest constellation points is equal to 2\sqrt{2}×Δ₄, that is, the distance is increased by only \sqrt{2} times, and a gain is exactly of 3 dB.

In this application, if the first sending is performed after modulation by using S¹₄, the second sending is performed after modulation by using S²₄, values sent in the two times of sending are respectively X=S¹₄+[Cᵢ] and Y=S²₄[Cᵢ], and a value of Cᵢ is of [0, 15], 16 constellation points in FIG. 3 are formed. It may be calculated that a distance between two adjacent closest constellation points is equal to 2\sqrt{17}×Δ₄, in other words, a minimum distance between constellation points in a two-dimensional constellation diagram formed by S¹₄ and S²₄ is greater than or equal to 2\sqrt{17}×Δ₄. In this implementation, the distance between the two adjacent constellation points in the two-dimensional constellation diagram can be nearly tripled. Therefore, in joint modulation of data, a bit error rate of data receiving can be reduced, and accuracy of the data receiving can be improved.

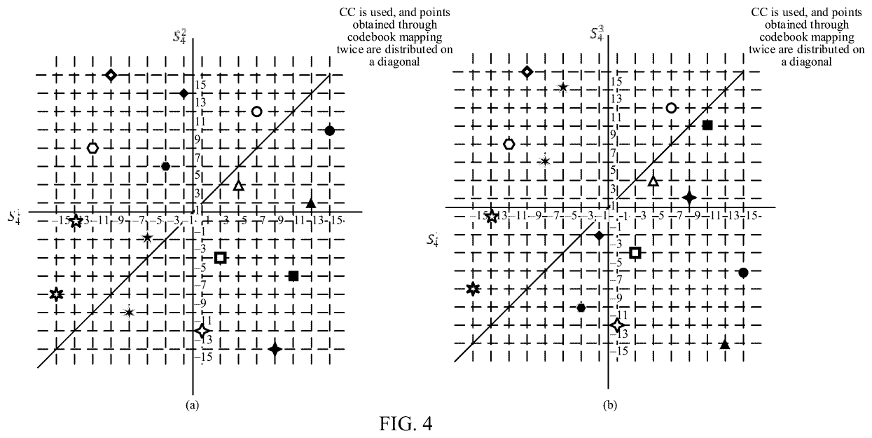

A virtual three-dimensional coordinate diagram is constructed, where a first-dimensional coordinate X represents a symbol amplitude sent for the first time, a second-dimensional coordinate Y represents a symbol amplitude sent for the second time, and a third-dimensional coordinate Z represents a symbol amplitude sent for the third time. The amplitudes sent in the three times of sending form a constellation point in the three-dimensional constellation diagram. FIG. 4 is a three-dimensional constellation diagram according to an embodiment of this application. FIG. 4(a) shows projections on an (X, Y) plane, and FIG. 4(b) shows projections on an (X, Z) plane. If a first device performs sending for all three times by using a same quadrature amplitude modulation codebook, and a value of Cᵢ is of [0, 15], a straight line in FIG. 4 is formed. Therefore, a distance between two adjacent closest constellation points is equal to 2\sqrt{3}×Δ₄. In comparison with sending only once, the distance between the constellation points is increased by only \sqrt{3} times, and a gain is of 4.77 dB. In this application, if the first sending is performed by using S¹₄, the second sending is performed by using S²₄, and the third sending is performed by using S³₄, values sent in the three times of sending are respectively X=S¹₄[Cᵢ], Y=S²₄[Cᵢ], and Z=S³₄[Cᵢ], and a value of Cᵢ is of [0, 15], 16 constellation points in FIG. 4 are formed. It may be calculated that a distance between two adjacent closest constellation points is equal to 2\sqrt{33}×Δ₄, in other words, a minimum distance between constellation points in a three-dimensional constellation diagram formed by S¹₄, S²₄, and S³₄ is greater than or equal to 2\sqrt{33}×Δ₄. The distance is increased by 3.3 times compared with the distance between the two adjacent closest constellation points when sending is performed for all the three times by using the same quadrature amplitude modulation codebook, and is increased by 5.75 times compared with a distance between two adjacent closest constellation points of initial transmission (the first sending). Therefore, in joint modulation of data, a bit error rate of data receiving can be reduced, and accuracy of the data receiving can be improved.

### Implementation 2:

A QAM 16 codebook whose QAM level is equal to 2 is used as an example. In modulation by using QAM 16, three different quadrature amplitude modulation codebooks may be supported. In this case, there is a quadrature amplitude modulation codebook combination S₂={S¹₂, S²₂, S³₂}. For example,

$${S}_{2}^{1} = \{ 3 , 1 , - 3 , - 1 \} ,$$

$${S}_{2}^{2} = \{ - 1 , 3 , 1 , - 3 \} , and$$

$${S}_{2}^{3} = \{ 1 , - 1 , 1 , - 1 \} .$$

An example in which a data set of the first data is the foregoing A={a₀, a₁, a₂ . . . a_{K-1}} is used. A first quadrature amplitude modulation codebook may be S¹₂, and a first device may send, to a second device, first data modulated by using S¹₂. A sending value that is when Bᵢ is sent by using the first quadrature amplitude modulation codebook is equal to S¹₂ [Cᵢ], where Cᵢ is a decimal number with a value of [0, 3]. For example, when Cᵢ is equal to 0, the sending value that is when Bᵢ is sent by using the first quadrature amplitude modulation codebook is equal to 3; when Cᵢ is equal to 1, the sending value that is when Bᵢ is sent by using the first quadrature amplitude modulation codebook is equal to 1; or when Cᵢ is equal to 2, the sending value that is when Bᵢ is sent by using the first quadrature amplitude modulation codebook is equal to −3.

A second quadrature amplitude modulation codebook may be S²₂. When the second device fails to decode the first data modulated by using S¹₂, the first device may send, to the second device, second data modulated by using S²₂, where the second data may be data the same as the first data, or may be a part of the first data. When the second data and the first data are the same data, a sending value that is when Bᵢ is sent by using the second quadrature amplitude modulation codebook may be equal to S²₂[Cᵢ] multiplying Δ₂.

A third quadrature amplitude modulation codebook may be S³₂. When the second device fails to jointly decode the first data modulated by using S¹₂ and the second data modulated by using S²₂, the first device may send, to the second device, third data modulated by using S³₂, where the third data may be data the same as the first data, or may be a part of the first data, and the third data and the second data may also be same data. When the third data and the first data are the same data, a sending value that is when Bᵢ is sent by using the third quadrature amplitude modulation codebook may be equal to S³₂ [Cᵢ] multiplying Δ₂. Optionally, the third quadrature amplitude modulation codebook may alternatively be S¹₂ or S²₂, or the third quadrature amplitude modulation codebook may be a QAM codebook whose QAM level is equal to 1.

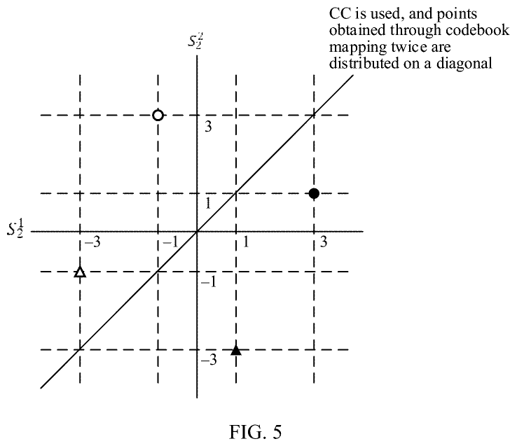

A virtual two-dimensional coordinate diagram is constructed, where a horizontal coordinate is a symbol amplitude sent for the first time, and a vertical coordinate is a symbol amplitude sent for the second time. The amplitudes sent in the two times of sending may form a constellation point in the two-dimensional constellation diagram. If the first sending is performed after modulation by using S¹₂, the second sending is performed after modulation by using S²₂, S¹₂ falls on an X-axis, S²₂ falls on a Y-axis, values sent in the two times of sending are respectively X=S¹₂[Cᵢ] and Y=S²₂[Cᵢ], and a value of Cᵢ is of [0, 3], four constellation points on an (X, Y) plane are formed. FIG. 5 is another two-dimensional constellation diagram according to an embodiment of this application. If a first device performs sending only once by using S¹₂, points on an X-axis are formed. Therefore, a distance between adjacent closest constellation points is equal to 2×Δ₂, where Δ₂ may be a normalized amplitude coefficient of S¹₂ or S²₂. If sending is performed twice by using S¹₂, in other words, CC retransmission is performed, X=Y. In this case, a value of Cᵢ is of [0, 3], and a straight line in FIG. 5 is formed. Therefore, a distance between adjacent closest constellation points is equal to 2\sqrt{2}×Δ₂, that is, the distance is increased by only \sqrt{2} times.

{(3×Δₓ, 1×Δ_{y}}), (1×Δₓ, −3×Δ_{y}), (−1×Δₓ, 1×Δ_{y}), (−3×Δₓ, −1×Δ_{y})} are referred to as basic points on an (X, Y) plane. It should be noted that an effect of a codebook written by using constellation points formed through mirroring is consistent with that of a codebook formed by the basic points. In this application, if the first sending is performed after modulation by using S¹₂, the second sending is performed after modulation by using S²₂, values sent in the two times of sending are respectively X=S¹₂[Cᵢ] and Y=S²₂[Cᵢ], and a value of Cᵢ is of [0, 3], four constellation points in FIG. 5 are formed. It may be calculated that a distance between two adjacent closest constellation points is equal to 2\sqrt{5}Δ₂, in other words, a minimum distance between constellation points in a two-dimensional constellation diagram formed by S¹₂ and S²₂ is greater than or equal to 2\sqrt{5}Δ₂.

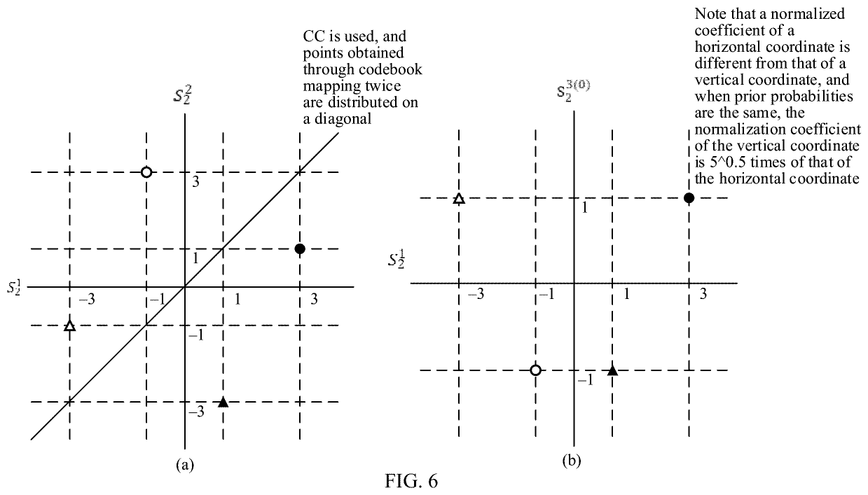

A virtual three-dimensional coordinate diagram is constructed, where a first-dimensional coordinate X represents a symbol amplitude sent for the first time, a second-dimensional coordinate Y represents a symbol amplitude sent for the second time, and a third-dimensional coordinate Z represents a symbol amplitude sent for the third time. The amplitudes sent in the three times of sending form a constellation point in the three-dimensional constellation diagram. If the first sending is performed after modulation by using S¹₂, the second sending is performed after modulation by using S²₂, the third sending is performed after modulation by using a QAM codebook S³⁽⁰⁾₂ whose QAM level is equal to 1, S¹₂ falls on an X-axis, S²₂ falls on a Y-axis, S³⁽⁰⁾₂ falls on a Z-axis, values sent in the three times of sending are respectively X=S¹₂[Cᵢ], Y=S²₂[Cᵢ], and Z=S³⁽⁰⁾₂[Cᵢ], and a value of Cᵢ is of [0, 3], four constellation points in three-dimensional space are formed. FIG. 6 is another three-dimensional constellation diagram according to an embodiment of this application. FIG. 6(a) shows projections on an (X, Y) plane, and FIG. 6(b) shows projections on an (X, Z) plane. It may be calculated that a distance between two adjacent closest constellation points is equal to 2\sqrt{10}Δ₂, in other words, a minimum distance between constellation points in a three-dimensional constellation diagram formed by S¹₂, S²₂, and S³⁽⁰⁾₂ is greater than or equal to 2\sqrt{10}Δ₂.

### Implementation 3:

A QAM 64 codebook whose QAM level is equal to 3 is used as an example. In modulation by using QAM 64, three different quadrature amplitude modulation codebooks may be supported. In this case, there is a quadrature amplitude modulation codebook combination S₃={S¹₃, S²₃, S³₃}. For example,

$${S}_{3}^{1} = \{ 7 , 5 , 1 , 3 , - 7 , - 5 , - 1 , - 3 \} ,$$

$${S}_{3}^{2} = \{ 3 , - 7 , 5 , - 1 , - 3 , 7 , - 5 , 1 \} , and$$

$${S}_{3}^{3} = \{ 5 , 1 , - 7 , - 3 , - 5 , - 1 , 7 , 3 \} .$$

An example in which a data set of the first data is the foregoing A={a₀, a₁, a₂ . . . a_{K-1}} is used. A first quadrature amplitude modulation codebook may be S¹₃, and a first device may send, to a second device, first data modulated by using S¹₃. A sending value that is when Bᵢ is sent by using the first quadrature amplitude modulation codebook is equal to S¹₃[Cᵢ], where Cᵢ is a decimal number with a value of [0, 7]. For example, when Cᵢ is equal to 0, the sending value that is when Bᵢ is sent by using the first quadrature amplitude modulation codebook is equal to 7; when Cᵢ is equal to 1, the sending value that is when Bᵢ is sent by using the first quadrature amplitude modulation codebook is equal to 5; or when Cᵢ is equal to 2, the sending value that is when Bᵢ is sent by using the first quadrature amplitude modulation codebook is equal to 1.

A second quadrature amplitude modulation codebook may be S²₃. When the second device fails to decode the first data modulated by using S¹₃, the first device may send, to the second device, second data modulated by using S²₃, where the second data may be data the same as the first data, or may be a part of the first data. When the second data and the first data are the same data, a sending value that is when Bᵢ is sent by using the second quadrature amplitude modulation codebook may be equal to S²₃[Cᵢ] multiplying Δ₃.

A third quadrature amplitude modulation codebook may be S³₃. When the second device fails to jointly decode the first data modulated by using S¹₃ and the second data modulated by using S²₃, the first device may send, to the second device, third data modulated by using S³₃, where the third data may be data the same as the first data, or may be a part of the first data, and the third data and the second data may also be same data. When the third data and the first data are the same data, a sending value that is when Bᵢ is sent by using the third quadrature amplitude modulation codebook may be equal to S³₃[Cᵢ] multiplying Δ₃. Optionally, the third quadrature amplitude modulation codebook may alternatively be S¹₃ or S²₃.

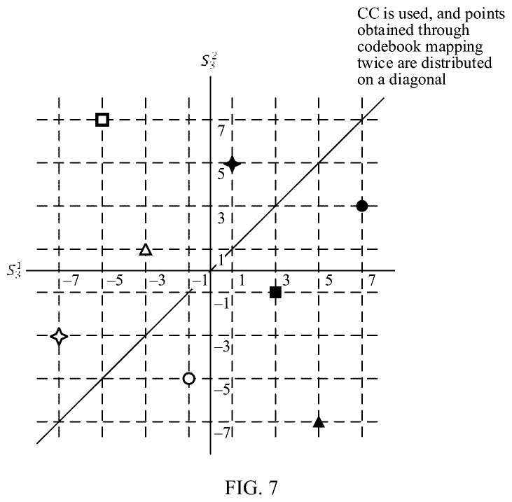

A virtual two-dimensional coordinate diagram is constructed, where a horizontal coordinate is a symbol amplitude sent for the first time, and a vertical coordinate is a symbol amplitude sent for the second time. The amplitudes sent in the two times of sending may form a constellation point in the two-dimensional constellation diagram. If the first sending is performed after modulation by using S¹₃, the second sending is performed after modulation by using S²₃, S¹₃ falls on an X-axis, S²₃ falls on a Y-axis, values sent in the two times of sending are respectively X=S¹₃[Cᵢ] and Y=S²₃[Cᵢ], and a value of Cᵢ is of [0, 7], eight constellation points on an (X, Y) plane are formed. FIG. 7 is another two-dimensional constellation diagram according to an embodiment of this application. If a first device performs sending only once by using S¹₃, points on an X-axis are formed. Therefore, a distance between adjacent closest constellation points is equal to 2×Δ₃, where Δ₃ may be a normalized amplitude coefficient of S¹₃ or S²₃. If sending is performed twice by using S¹₃, in other words, CC retransmission is performed, X=Y. In this case, a value of Cᵢ is of [0, 7], and a straight line in FIG. 7 is formed. Therefore, a distance between adjacent closest constellation points is equal to 2\sqrt{2}×Δ₃, that is, the distance is increased by only 2 times.

$$\{ ( 7 \times {Δ}_{x} , 3 \times {Δ}_{y} ) , ( 5 \times {Δ}_{x} , - 7 \times {Δ}_{y} ) , \\ ( 3 \times {Δ}_{x} , - 1 \times {Δ}_{y} ) , ( 1 \times {Δ}_{x} , 5 \times {Δ}_{y} ) , ( - 1 \times {Δ}_{x} , - 5 \times {Δ}_{y} ) , \\ ( - 3 \times {Δ}_{x} , 1 \times {Δ}_{y} ) , ( - 5 \times {Δ}_{x} , 7 \times {Δ}_{y} ) , ( - 7 \times {Δ}_{x} , - 3 \times {Δ}_{y} ) \}$$

are referred to as basic points on an (X, Y) plane. It should be noted that an effect of a codebook written by using constellation points formed through X-axis symmetric mirroring, Y-axis symmetric mirroring, and X-axis and Y-axis symmetric mirroring of the basic points is consistent with that of a QAM 64 codebook combination of S¹₃ and S²₃. In this application, if the first sending is performed after modulation by using S¹₃, the second sending is performed after modulation by using S²³, values sent in the two times of sending are respectively X=S¹₃[Cᵢ] and Y=S²₃[Cᵢ], and a value of Cᵢ is of [0, 7], eight constellation points in FIG. 7 are formed. It may be calculated that a distance between two adjacent closest constellation points is equal to 2843, in other words, a minimum distance between constellation points in a two-dimensional constellation diagram formed by S¹₂ and S²₂ is greater than or equal to 2\sqrt{8}Δ₃.

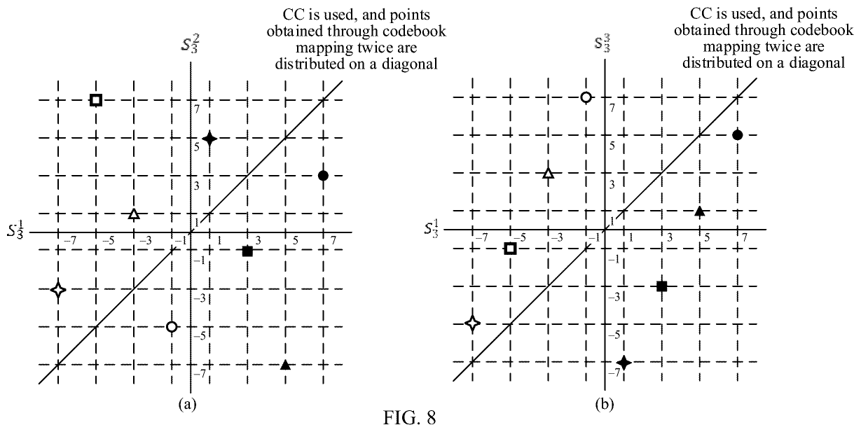

A virtual three-dimensional coordinate diagram is constructed, where a first-dimensional coordinate X represents a symbol amplitude sent for the first time, a second-dimensional coordinate Y represents a symbol amplitude sent for the second time, and a third-dimensional coordinate Z represents a symbol amplitude sent for the third time. The amplitudes sent in the three times of sending form a constellation point in the three-dimensional constellation diagram. If the first sending is performed after modulation by using S¹₃, the second sending is performed after modulation by using S²₃, the third sending is performed after modulation by using S³₃, S¹₂ falls on an X-axis, S²₂ falls on a Y-axis, S³₃ falls on a Z-axis, values sent in the three times of sending are respectively X=S¹₂[Cᵢ], Y=S²₂[Cᵢ], and Z=S³₃[Cᵢ], and a value of Cᵢ is of [0, 7], eight constellation points in the three-dimensional space are formed. FIG. 8 is another three-dimensional constellation diagram according to an embodiment of this application. FIG. 8(a) shows projections on an (X, Y) plane, and FIG. 8(b) shows projections on an (X, Z) plane. It may be calculated that a distance between two adjacent closest constellation points is equal to 2\sqrt{14}Δ₃, in other words, a minimum distance between constellation points in a three-dimensional constellation diagram formed by S¹₃, S²₃, and S³₃ is greater than or equal to 2\sqrt{14}Δ₃.

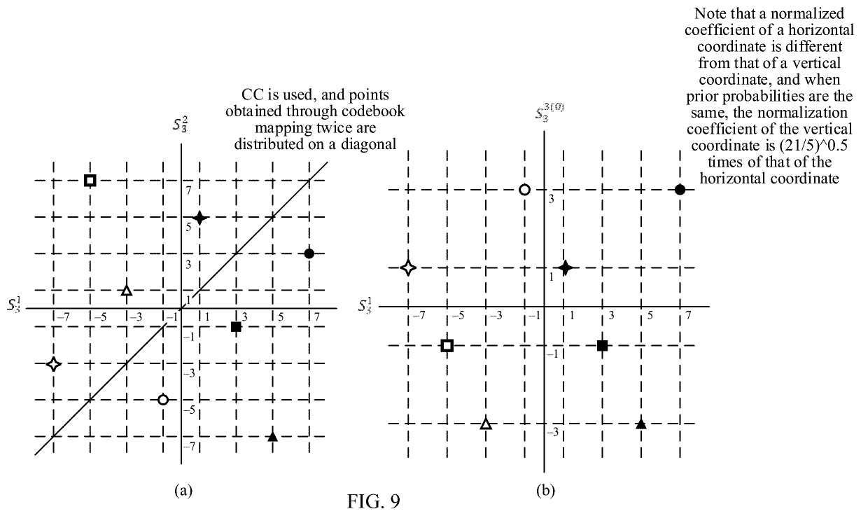

If the first sending is performed after modulation by using S¹₃, the second sending is performed after modulation by using S²₃, the third sending is performed after modulation by using a QAM codebook S³⁽⁰⁾₃, whose QAM level is equal to 2, S¹₂ falls on an X-axis, S²₂ falls on a Y-axis, S³⁽⁰⁾₃ falls on a Z-axis, values sent in the three times of sending are respectively X=S¹₂[C], Y=S²₂[Cᵢ], and Z=S³⁽⁰⁾₃[Cᵢ], and a value of Cᵢ is of [0, 7], eight constellation points in the three-dimensional space are formed. FIG. 9 is another three-dimensional constellation diagram according to an embodiment of this application. FIG. 9(a) shows projections on an (X, Y) plane, and FIG. 9(b) shows projections on an (X, Z) plane. It can be learned that eight constellation points in FIG. 9(b) are distributed on four lines parallel to an X-axis. Therefore, Z-axis coordinates of two constellation points on each line parallel to the X-axis are the same. It may be calculated that a distance between two adjacent closest constellation points is equal to 2\sqrt{71/5}Δ₃, in other words, a minimum distance between constellation points in a three-dimensional constellation diagram formed by S¹₃, S²₃, and S³₃ is greater than or equal to 2\sqrt{71/5}Δ₃.

The following compares and describes transmission performance of data retransmission performed by using a CC technology, an LDPC incremental redundancy technology, and a polar incremental redundancy technology.

I. A QAM 16 codebook whose QAM level is equal to 2 is used as an example, and a codebook combination is the foregoing S₂={S¹₂, S²₂, S³₂}.

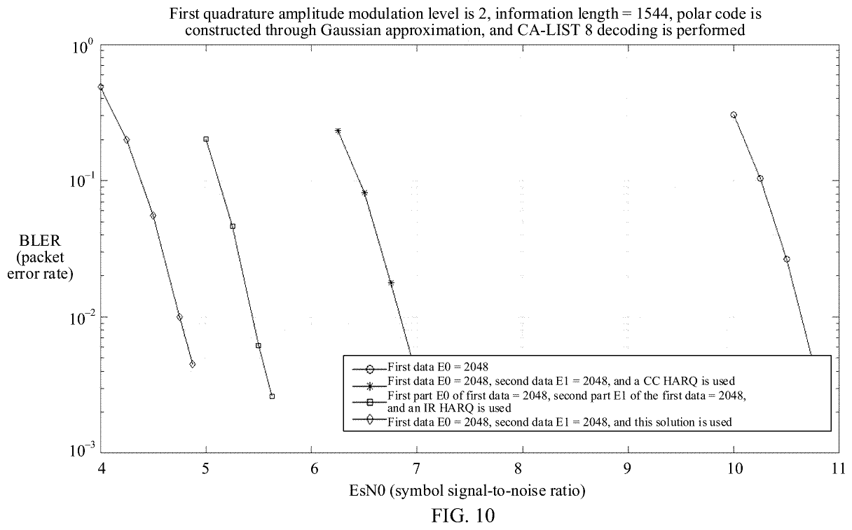

FIG. 10 is a diagram of a relationship between packet error rates (block error rates, BLERs) and symbol signal-to-noise ratios (EsN0s) corresponding to different data sending manners. A horizontal coordinate is the EsN0, and a vertical coordinate is the BLER. The different sending manners include sending only first data or decoding only the first data, a CC-HARQ, an IR-HARQ, and the retransmission solution provided in embodiments of this application. Retransmission length=initial transmission length, in other words, a length of second data is equal to a length of the first data. For example, the length of the first data and the length of the second data are equal to 2048, and an information length of the first data and an information length of the second data are equal to 1544. It can be learned from FIG. 10 that, when a bit error rate is low, for example, the bit error rate is less than 10⁻², a symbol signal-to-noise ratio in this solution is the lowest.

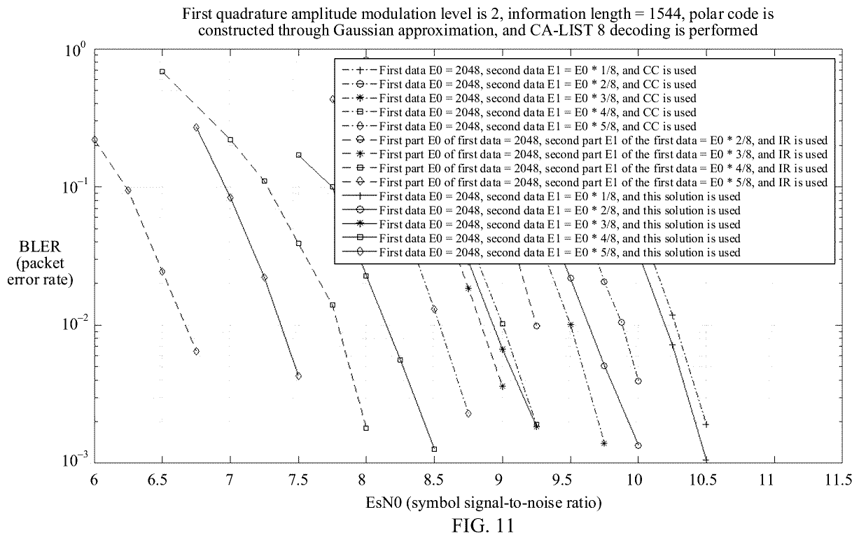

FIG. 11 is another diagram of a relationship between BLERs and EsN0s corresponding to different data sending manners. A horizontal coordinate is the EsN0, and a vertical coordinate is the BLER. A solid line represents the retransmission solution provided in embodiments of this application, and second data is sent after modulation by using S²₂; a dash-dotted line represents a CC-HARQ; and a dashed line represents a polar code IR-HARQ. Retransmission length E1=initial transmission length E0*⅛*{1,2,3,4,5}, in other words, a length of the second data is equal to a length of first data*⅛*{1,2,3,4,5}. For example, the length of the first data is equal to 2048, and an information length of the first data is equal to 1544. It can be learned from FIG. 11 that, when E1s are the same, and a bit error rate is low, for example, the bit error rate is less than 10⁻², a symbol signal-to-noise ratio in this solution is closest to a symbol signal-to-noise ratio of the polar code IR-HARQ.

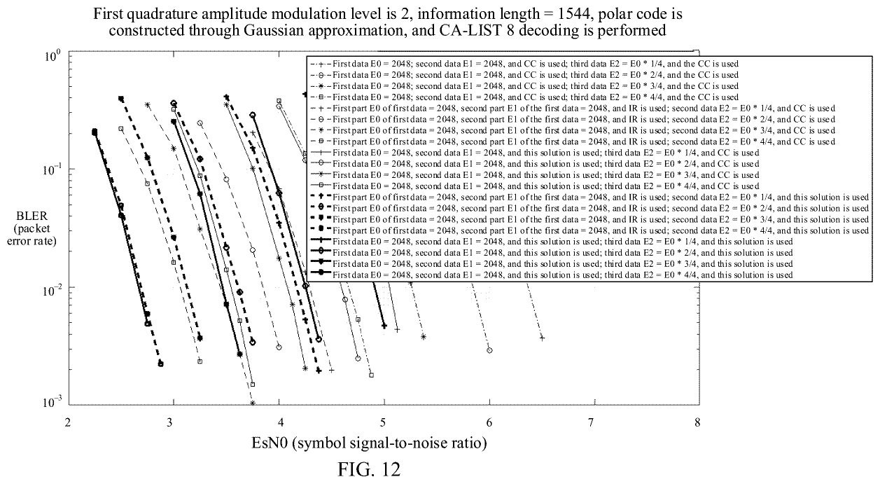

FIG. 12 is another diagram of a relationship between BLERs and EsN0s corresponding to different data sending manners. A horizontal coordinate is the EsN0, and a vertical coordinate is the BLER. A solid line represents that second data is sent after modulation by using S²₂, and third data is sent after modulation by using S¹₂ (namely, a CC-HARQ); a dash-dotted line represents the CC-HARQ, and S¹₂ is used as modulation codebooks of the second data and the third data both; a dotted line represents that a second part of first data is sent by using a polar code IR-HARQ, the second data is sent by using the CC-HARQ, and S¹₂ is used as modulation codebooks of the first data and the second data both; a thick dashed line represents that the second part of the first data is sent by using the polar code IR-HARQ, the second data is sent according to the retransmission solution in this application, S¹₂ is used as the modulation codebook of the first data, and S²₂ is used as the modulation codebook of the second data; and a thick solid line represents the retransmission solution provided in embodiments of this application, S¹₂ is used as the modulation codebook of the first data, S²₂ is used as the modulation codebook of the second data, and S³₂ is used as the modulation codebook of the third data. A length E1 of the second data is equal to a length (an initial transmission length E0) of the first data. Length E2 of the third data=initial transmission length E0*¼*{1,2,3,4}. In other words, a part or all of bits of the first data are sent for three times. For example, the length of the first data is equal to 2048, and an information length of the first data is equal to 1544. It can be learned from FIG. 12 that, when a bit error rate is low, for example, the bit error rate is less than 10⁻², a symbol signal-to-noise ratio in this solution is the lowest.

It should be understood that, when there is no IR-HARQ, the first data is used for initial transmission, the second data is used for retransmission, and the third data is used for further retransmission. If there is the IR-HARQ, it should be understood that the first data is used for initial transmission and retransmission both, and data used for further retransmission is the second data.

Therefore, according to the technical solution provided in embodiments of this application, encoding and decoding complexity can be reduced, and accuracy of data receiving can be improved.

II. A QAM 64 codebook whose QAM level is equal to 3 is used as an example, and a codebook combination is the foregoing S₃={S¹₃, S²₃, S³₃}.

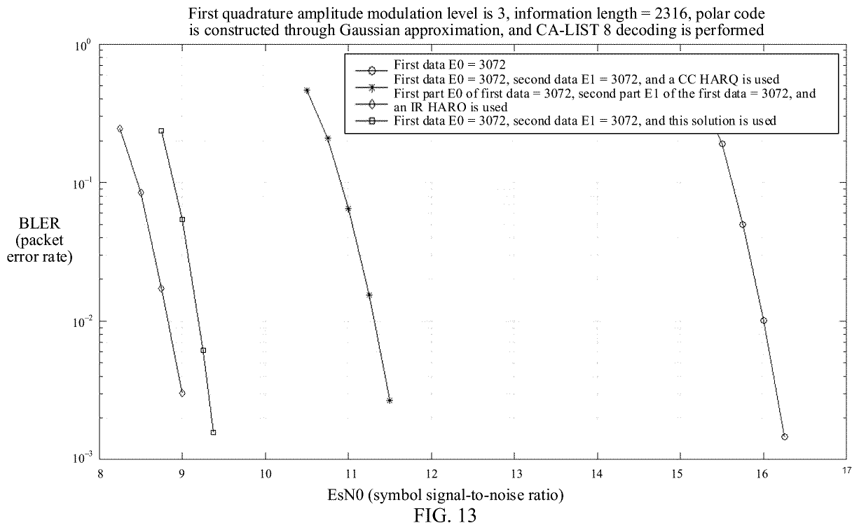

FIG. 13 is a diagram of a relationship between BLERs and EsN0s corresponding to different data sending manners. A horizontal coordinate is the EsN0, and a vertical coordinate is the BLER. The different sending manners include sending only first data or decoding only the first data, a CC-HARQ, an IR-HARQ, and the retransmission solution provided in embodiments of this application. For example, a length of the first data is equal to 3072, an information length of the first data is equal to 1544, and a length of second data is equal to 2316. It can be learned from FIG. 13 that, when a bit error rate is low, for example, the bit error rate is less than 10⁻², a symbol signal-to-noise ratio in this solution is closest to a symbol signal-to-noise ratio of the IR-HARQ.

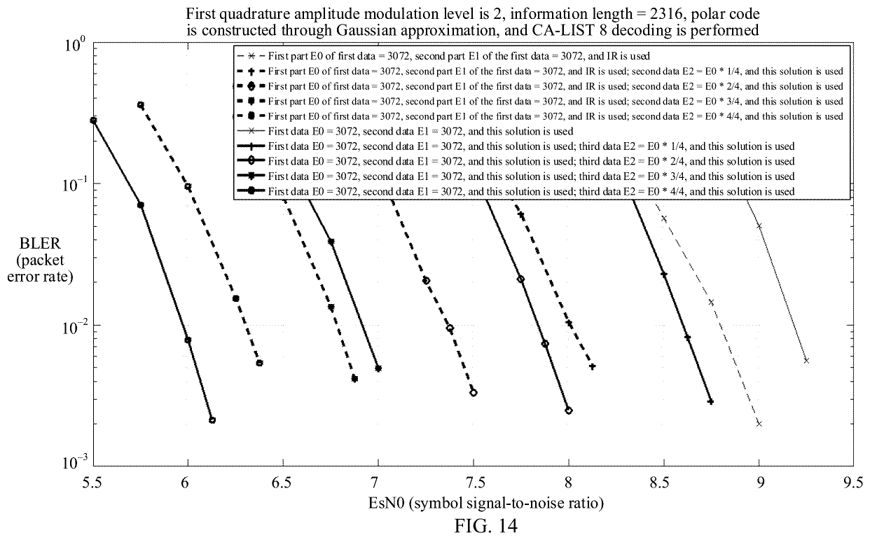

FIG. 14 is another diagram of a relationship between BLERs and EsN0s corresponding to different data sending manners. A horizontal coordinate is the EsN0, and a vertical coordinate is the BLER. A thick solid line represents the retransmission solution provided in embodiments of this application, S¹₃ is used as a modulation codebook of first data, S²₃ is used as a modulation codebook of second data, and S³₃ is used as a modulation codebook of third data; and a thick dashed line represents that a second part of the first data is sent by using a polar code IR-HARQ, the second data is sent according to the retransmission solution of this application, S¹₃ is used as the modulation codebook of the first data, and S²₃ is used as the modulation codebook of the second data. A length E1 of the second data is equal to a length (an initial transmission length E0) of the first data. Length E2 of the third data=initial transmission length E0*¼*{0,1,2,3,4}. In other words, a part or all of bits of the first data are sent for three times. For example, the length of the first data is equal to 3072, and an information length of the first data is equal to 1544. It can be learned from FIG. 14 that, when E2s are the same, and a bit error rate is low, for example, the bit error rate is less than 10-2, a symbol signal-to-noise ratio in this solution is the lowest. Therefore, according to the technical solution provided in embodiments of this application, encoding and decoding complexity can be reduced, and accuracy of data receiving can be improved.

III. A QAM 256 codebook whose QAM level is equal to 4 is used as an example, and a codebook combination is the foregoing S+={S¹₄, S²₄, S³₄}.

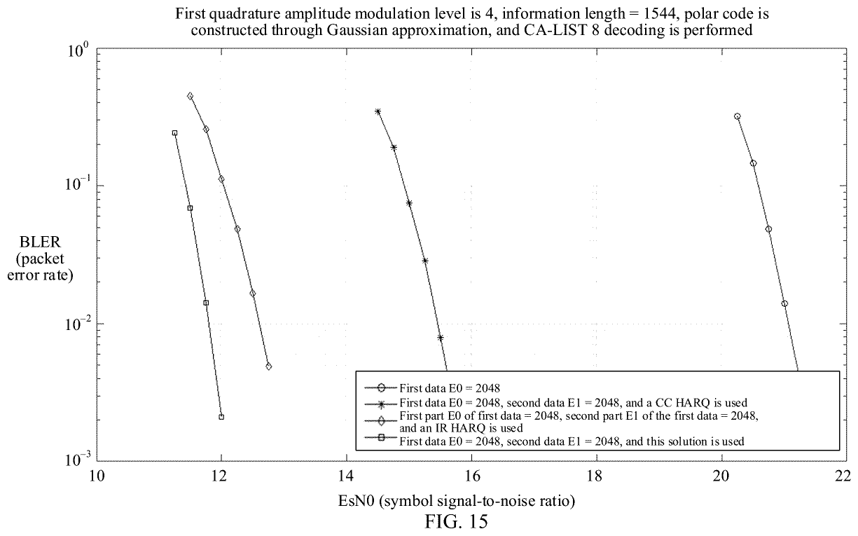

FIG. 15 is a diagram of a relationship between BLERs and EsN0s corresponding to different data sending manners. A horizontal coordinate is the EsN0, and a vertical coordinate is the BLER. The different sending manners include sending only first data or decoding only the first data, a CC-HARQ, an IR-HARQ, and the retransmission solution provided in embodiments of this application. Retransmission length=initial transmission length, in other words, a length of second data is equal to a length of the first data. For example, the length of the first data and the length of the second data are equal to 2048, and an information length of the first data and an information length of the second data are equal to 1544. It can be learned from FIG. 13 that, when a bit error rate is low, for example, the bit error rate is less than 10⁻², a symbol signal-to-noise ratio in this solution is the lowest.

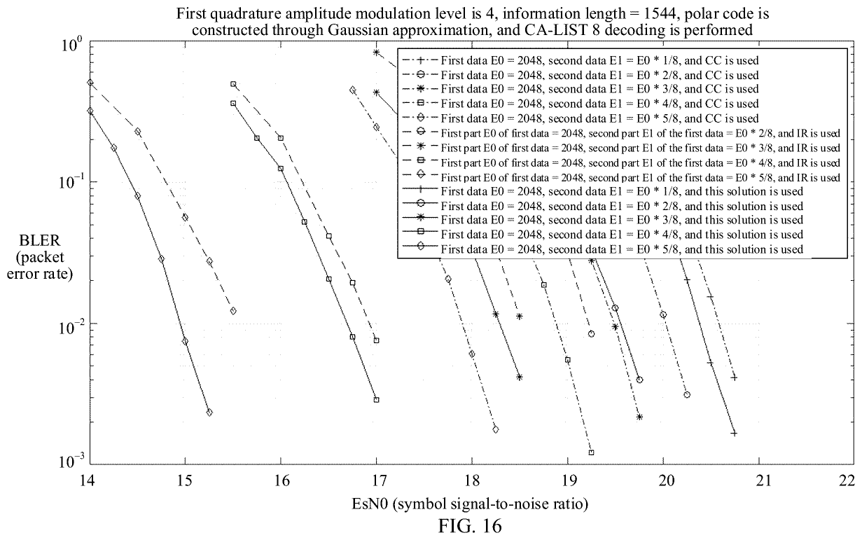

FIG. 16 is another diagram of a relationship between BLERs and EsN0s corresponding to different data sending manners. A horizontal coordinate is the EsN0, and a vertical coordinate is the BLER. A solid line represents the retransmission solution provided in embodiments of this application, and second data is sent after modulation by using S₂⁴; a dash-dotted line represents a CC-HARQ; and a dashed line represents a polar code IR-HARQ. Retransmission length E1=initial transmission length E0*⅛*{1,2,3,4,5}, in other words, a length of the second data is equal to a length of first data*⅛*{1,2,3,4,5}. For example, the length of the first data is equal to 2048, and an information length of the first data is equal to 1544. It can be learned from FIG. 16 that, when E1s are the same, and a bit error rate is low, for example, the bit error rate is less than 10⁻², a symbol signal-to-noise ratio in this solution is the lowest.

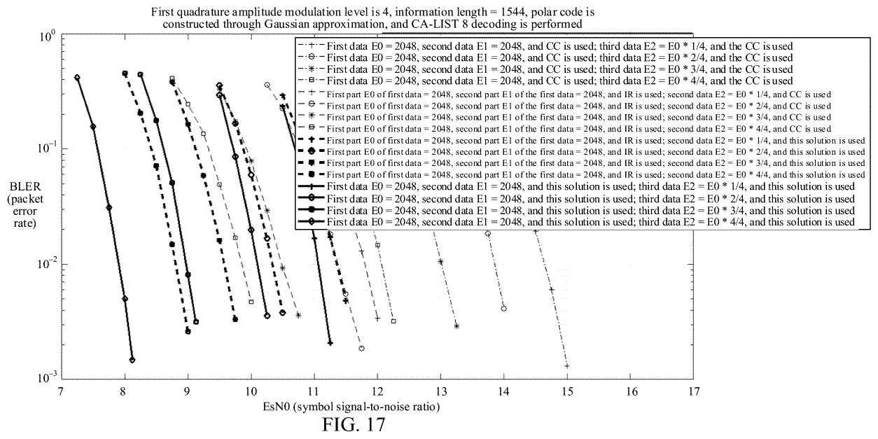

FIG. 17 is another diagram of a relationship between BLERs and EsN0s corresponding to different data sending manners. A horizontal coordinate is the EsN0, and a vertical coordinate is the BLER. A thick solid line represents the retransmission solution provided in embodiments of this application, first data is sent after modulation by using S¹₄, second data is sent after modulation by using S²₄, and third data is sent after modulation by using S³₄; a dash-dotted line represents a CC-HARQ, and S¹₄ is used as modulation codebooks for all data; a dashed line represents that a second part of the first data is sent by using a polar code IR-HARQ, the second data is sent by using the CC-HARQ, and S¹₄ is used as modulation codebooks for the first data and the second data both; and a thick dashed line represents that the second part of the first data is sent by using the polar code IR-HARQ, the second data is sent according to the retransmission solution in this application, S¹₄ is used as the modulation codebook of the first data, and S²₄ is used as the modulation codebook of the second data. A length E1 of the second data is equal to a length of the first data (an initial transmission length E0), and length E2 of the third data=initial transmission length E0*¼*{1, 2, 3, 4}. For example, the length of the first data is equal to 2048, and an information length of the first data is equal to 1544. It can be learned from FIG. 17 that, when E1 and E2 are the same, and a bit error rate is low, for example, the bit error rate is less than 10⁻², a symbol signal-to-noise ratio in this solution is the lowest.

Therefore, according to the technical solution provided in embodiments of this application, encoding and decoding complexity can be reduced, and accuracy of data receiving can be improved.

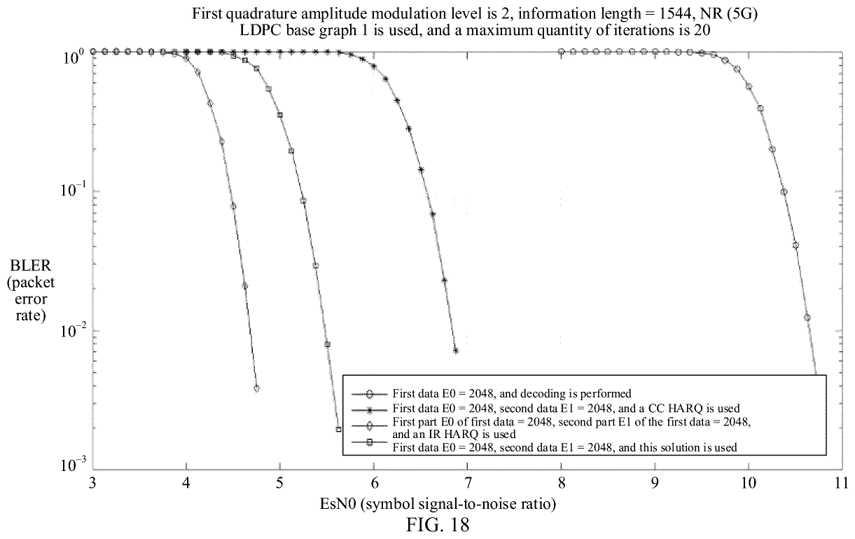

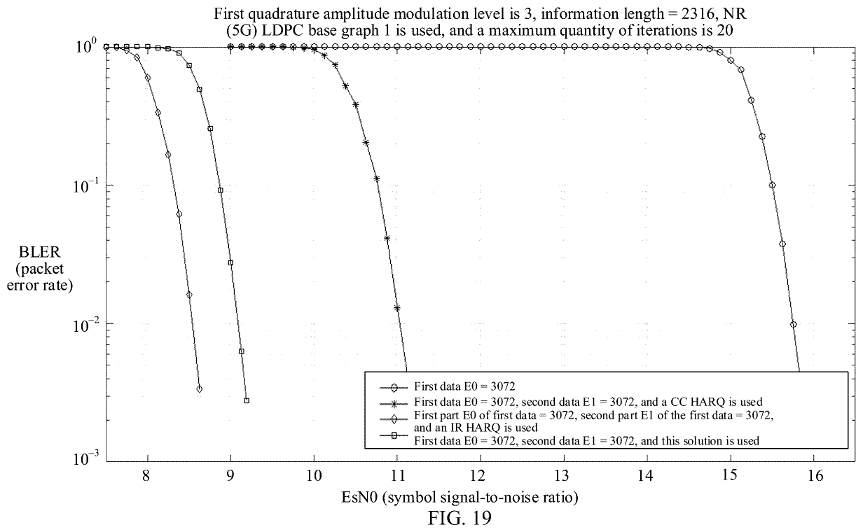

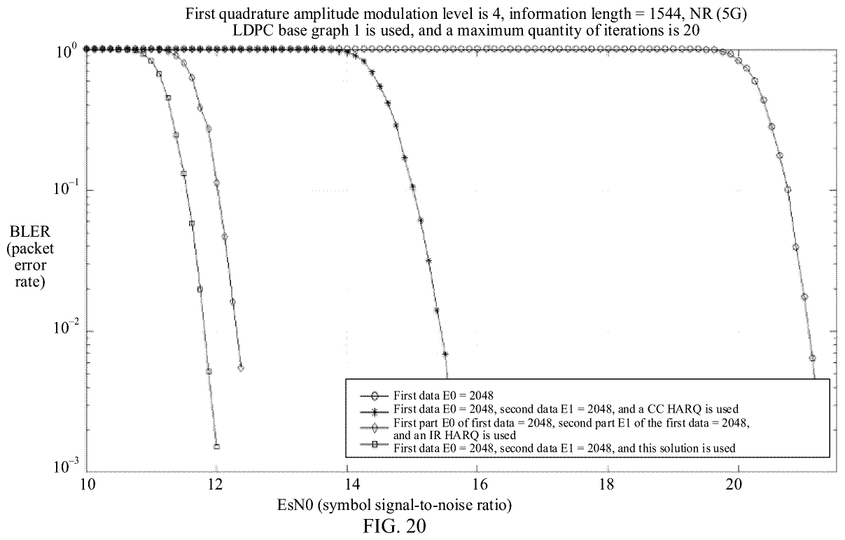

FIG. 18 to FIG. 20 are performance comparison diagrams corresponding to different data sending manners. In the figures, a circle represents performance of initial transmission, an asterisk represents performance of a CC-HARQ, a square represents performance of this solution, and a diamond represents performance of an LDPC long code IR-HARQ. It can be learned that decoding performance of this solution is close to or greater than that of the long code IR-HARQ, but complexity is excessively low, and is far lower than complexity of decoding a piece of long code formed by using an IR-HARQ.

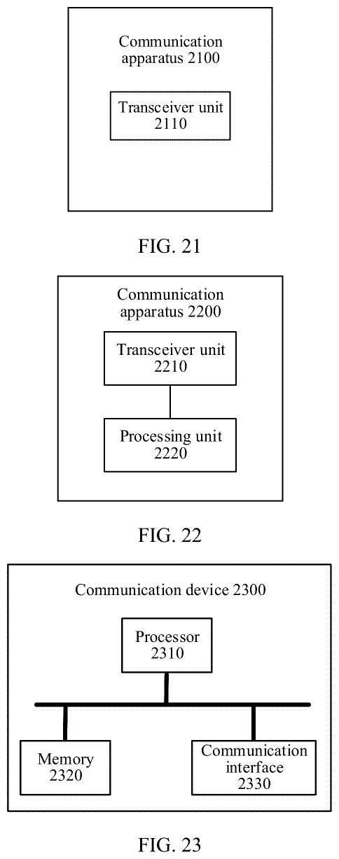

An embodiment of this application provides a communication apparatus. FIG. 21 is a schematic block diagram of the communication apparatus 2100 according to this embodiment of this application. The apparatus may be used in the first network device in embodiments of this application. The communication apparatus 2100 includes:

a transceiver unit 2110, configured to send, to a second device, first data modulated by using a first quadrature amplitude modulation codebook; and

the transceiver unit 2110 is further configured to: when the second device fails to decode the first data modulated by using the first quadrature amplitude modulation codebook, send, to the second device, second data modulated by using a second quadrature amplitude modulation codebook, where the second data is a subset of the first data, and the first quadrature amplitude modulation codebook is different from the second quadrature amplitude modulation codebook.

Optionally, a minimum distance between constellation points in a two-dimensional constellation diagram formed by the first quadrature amplitude modulation codebook and the second quadrature amplitude modulation codebook is greater than or equal to a first threshold.

Optionally, the transceiver unit 2110 is further configured to: when the second device fails to jointly decode the first data and the second data, send, to the second device, third data modulated by using a third quadrature amplitude modulation codebook, where the third data is a subset of the first data.

Optionally, at least one of the first quadrature amplitude modulation codebook and the second quadrature amplitude modulation codebook is different from the third quadrature amplitude modulation codebook.

Optionally, a minimum distance between constellation points in a three-dimensional constellation diagram formed by the first quadrature amplitude modulation codebook, the second quadrature amplitude modulation codebook, and the third quadrature amplitude modulation codebook is greater than or equal to a second threshold, where the second threshold is greater than the first threshold.

Optionally, when quadrature amplitude modulation levels of the first quadrature amplitude modulation codebook and the second quadrature amplitude modulation codebook are equal to 2, the first threshold is equal to 2\sqrt{5}Δ₂, where Δ₂ is a normalized amplitude coefficient of the first quadrature amplitude modulation codebook or the second quadrature amplitude modulation codebook;

when quadrature amplitude modulation levels of the first quadrature amplitude modulation codebook and the second quadrature amplitude modulation codebook are equal to 3, the first threshold is equal to 2\sqrt{8}Δ₃, where Δ₃ is a normalized amplitude coefficient of the first quadrature amplitude modulation codebook or the second quadrature amplitude modulation codebook; or when quadrature amplitude modulation levels of the first quadrature amplitude modulation codebook and the second quadrature amplitude modulation codebook are equal to 4, the first threshold is equal to 2\sqrt{17}Δ₄, where Δ₄ is a normalized amplitude coefficient of the first quadrature amplitude modulation codebook or the second quadrature amplitude modulation codebook.

Optionally, when the quadrature amplitude modulation levels of the first quadrature amplitude modulation codebook and the second quadrature amplitude modulation codebook are equal to 2, and a quadrature amplitude modulation level of the third quadrature amplitude modulation codebook is equal to 1, the second threshold is equal to 2\sqrt{10}Δ₂;

when the quadrature amplitude modulation levels of the first quadrature amplitude modulation codebook and the second quadrature amplitude modulation codebook are equal to 3, the second threshold is equal to 2\sqrt{14}Δ₃ or 2\sqrt{71/5}Δ₃; or when the quadrature amplitude modulation levels of the first quadrature amplitude modulation codebook and the second quadrature amplitude modulation codebook are equal to 4, the second threshold is equal to 2\sqrt{33}Δ₄ or 2\sqrt{34}Δ₄.

Optionally, the first data is data sent for a single time or data sent for a plurality of times.

An embodiment of this application provides a communication apparatus. FIG. 22 is a schematic block diagram of the communication apparatus 2200 according to this embodiment of this application. The apparatus may be used in the second device in embodiments of this application. The communication apparatus 2200 includes:
a transceiver unit 2210, configured to receive, from a first device, first data modulated by using a first quadrature amplitude modulation codebook, where
the transceiver unit 2210 is further configured to: when the first data modulated by using the first quadrature amplitude modulation codebook fails to be decoded, receive, from the first device, second data modulated by using a second quadrature amplitude modulation codebook, where the second data is a subset of the first data, and the first quadrature amplitude modulation codebook is different from the second quadrature amplitude modulation codebook; and
a processing unit 2220, configured to jointly decode the first data and the second data.

Optionally, a minimum distance between constellation points in a two-dimensional constellation diagram formed by the first quadrature amplitude modulation codebook and the second quadrature amplitude modulation codebook is greater than or equal to a first threshold.

Optionally, the transceiver unit 2210 is further configured to: when the first data and the second data fail to be jointly decoded, receive, from the first device, third data modulated by using a third quadrature amplitude modulation codebook, where the third data is a subset of the first data.

Optionally, at least one of the first quadrature amplitude modulation codebook and the second quadrature amplitude modulation codebook is different from the third quadrature amplitude modulation codebook.

Optionally, a minimum distance between constellation points in a three-dimensional constellation diagram formed by the first quadrature amplitude modulation codebook, the second quadrature amplitude modulation codebook, and the third quadrature amplitude modulation codebook is greater than or equal to a second threshold, where the second threshold is greater than the first threshold.

Optionally, when quadrature amplitude modulation levels of the first quadrature amplitude modulation codebook and the second quadrature amplitude modulation codebook are equal to 2, the first threshold is equal to 2\sqrt{5}Δ₂, where Δ₂ is a normalized amplitude coefficient of the first quadrature amplitude modulation codebook or the second quadrature amplitude modulation codebook;
when quadrature amplitude modulation levels of the first quadrature amplitude modulation codebook and the second quadrature amplitude modulation codebook are equal to 3, the first threshold is equal to 2\sqrt{8}Δ₃, where Δ₄ is a normalized amplitude coefficient of the first quadrature amplitude modulation codebook or the second quadrature amplitude modulation codebook; or
when quadrature amplitude modulation levels of the first quadrature amplitude modulation codebook and the second quadrature amplitude modulation codebook are equal to 4, the first threshold is equal to 2\sqrt{17}Δ₄, where Δ₄ is a normalized amplitude coefficient of the first quadrature amplitude modulation codebook or the second quadrature amplitude modulation codebook.

Optionally, when the quadrature amplitude modulation levels of the first quadrature amplitude modulation codebook and the second quadrature amplitude modulation codebook are equal to 2, and a quadrature amplitude modulation level of the third quadrature amplitude modulation codebook is equal to 1, the second threshold is equal to 2\sqrt{10}Δ₂;
when the quadrature amplitude modulation levels of the first quadrature amplitude modulation codebook and the second quadrature amplitude modulation codebook are equal to 3, the second threshold is equal to 2\sqrt{14}Δ₃ or 2\sqrt{71/5}Δ₃; or
when the quadrature amplitude modulation levels of the first quadrature amplitude modulation codebook and the second quadrature amplitude modulation codebook are equal to 4, the second threshold is equal to 2\sqrt{33}Δ₄, or 2\sqrt{34}Δ₄.

Optionally, the first data is data sent for a single time or data sent for a plurality of times.

An embodiment of this application provides a communication device 2300. FIG. 23 is a schematic block diagram of the communication device 2300 according to this embodiment of this application.

The communication device 2300 includes a processor 2310, a memory 2320, and a communication interface 2330.

The memory 2320 is configured to store executable instructions.

The processor 2310 is coupled to the memory 2320 through the communication interface 2330. The processor 2310 is configured to invoke and run the executable instructions in the memory 2320, to implement the method in embodiments of this application. The communication device may be the first device or the second device in embodiments of this application.

The processor 2310 may be an integrated circuit chip, and has a capability of processing a signal. In an implementation process, the steps in the foregoing method embodiments may be implemented through an integrated logic circuit of hardware in the processor or instructions in a form of software. The foregoing processor may be a general-purpose processor, a digital signal processor (digital signal processor, DSP), an application-specific integrated circuit (application specific integrated circuit, ASIC), a field programmable gate array (field programmable gate array, FPGA) or another programmable logic device, a discrete gate or transistor logic device, or a discrete hardware component. It may implement or perform the methods, the steps, and logical block diagrams that are disclosed in embodiments of this application. The general-purpose processor may be a microprocessor, or the processor may be any conventional processor or the like. The steps in the methods disclosed with reference to embodiments of this application may be directly performed and completed by a hardware decoding processor, or may be performed and completed through a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps in the foregoing methods in combination with the hardware in the processor.

Optionally, an embodiment of this application further provides a communication device. The communication device includes an input/output interface and a logic circuit. The input/output interface is configured to obtain input information and/or output information, and the logic circuit is configured to perform the method in any one of the foregoing method embodiments, and perform processing and/or generate output information based on the input information.

An embodiment of this application further provides a computer-readable storage medium. The computer-readable storage medium stores a computer program used to implement the method in the foregoing method embodiments. When the computer program is run on a computer, the computer is enabled to implement the method in the foregoing method embodiments.

An embodiment of this application further provides a computer program product. The computer program product includes computer program code. When the computer program code is run on a computer, the method in the foregoing method embodiments is performed.

An embodiment of this application further provides a chip, including a processor, where the processor is connected to a memory, the memory is configured to store a computer program, and the processor is configured to execute the computer program stored in the memory, to enable the chip to perform the method in the foregoing method embodiments.

It should be understood that in embodiments of this application, numbers “first”, “second”, and the like are merely used to distinguish between different objects, for example, to distinguish between different devices, and do not constitute a limitation on the scope of embodiments of this application. Embodiments of this application are not limited thereto.

The term “and/or” in this application describes only an association relationship for describing associated objects and represents that three relationships may exist. For example, A and/or B may represent the following three cases: Only A exists, both A and B exist, and only B exists. In addition, the character “/” in this specification usually represents an “or” relationship between associated objects. In this application, the term “at least one” may represent “one” or “two or more”. For example, at least one of A, B, and C may represent the following seventh cases: Only A exists, only B exists, only C exists, both A and B exist, both A and C exist, and both C and B exist, and A, B, C all exist.

A person of ordinary skill in the art may be aware that, in combination with the examples described in embodiments disclosed in this specification, units and algorithm steps may be implemented by electronic hardware or a combination of computer software and the electronic hardware. Whether the functions are performed by hardware or software depends on particular applications and design constraint conditions of the technical solutions. A person skilled in the art may use different methods to implement the described functions for each specific application, but such implementation should not be considered beyond the scope of this application.

A person skilled in the art may clearly learn that, for the purpose of convenient and brief description, for a specific working process of the foregoing system, apparatus, and unit, refer to a corresponding process in the foregoing method embodiments. Details are not described herein again.

In embodiments provided in this application, it should be understood that the disclosed system, apparatus, and method may be implemented in another manner. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, or each of the units may exist alone physically, or two or more units are integrated into one unit.

When the functions are implemented in a form of a software functional unit and sold or used as an independent product, the functions may be stored in a computer-readable storage medium. Based on this understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, or a network device) to perform all or some of the steps of the methods described in embodiments of this application. The foregoing storage medium includes any medium that can store program code, such as a USB flash drive, a removable hard disk, a read-only memory (read-only memory, ROM), a random access memory (random access memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A data sending method, comprising:
sending, by a first device to a second device, first data modulated by using a first quadrature amplitude modulation codebook; and
when the second device fails to decode the first data modulated by using the first quadrature amplitude modulation codebook, sending, by the first device to the second device, second data modulated by using a second quadrature amplitude modulation codebook, wherein the second data is a subset of the first data, and the first quadrature amplitude modulation codebook is different from the second quadrature amplitude modulation codebook.

2. A data receiving method, comprising:
receiving, by a second device from a first device, first data modulated by using a first quadrature amplitude modulation codebook;
when the second device fails to decode the first data modulated by using the first quadrature amplitude modulation codebook, receiving, by the second device from the first device, second data modulated by using a second quadrature amplitude modulation codebook, wherein the second data is a subset of the first data, and the first quadrature amplitude modulation codebook is different from the second quadrature amplitude modulation codebook; and
jointly decoding, by the second device, the first data and the second data.

3. The method according to claim 1, wherein
a minimum distance between constellation points in a two-dimensional constellation diagram formed by the first quadrature amplitude modulation codebook and the second quadrature amplitude modulation codebook is greater than or equal to a first threshold.

4. The method according to claim 1, wherein the method further comprises:
when the second device fails to jointly decode the first data and the second data, sending, by the first device to the second device, third data modulated by using a third quadrature amplitude modulation codebook, wherein the third data is a subset of the first data.

5. The method according to claim 4, wherein
at least one of the first quadrature amplitude modulation codebook and the second quadrature amplitude modulation codebook is different from the third quadrature amplitude modulation codebook.

6. The method according to claim 4, wherein
a minimum distance between constellation points in a three-dimensional constellation diagram formed by the first quadrature amplitude modulation codebook, the second quadrature amplitude modulation codebook, and the third quadrature amplitude modulation codebook is greater than or equal to a second threshold, wherein the second threshold is greater than the first threshold.

7. The method according to claim 3, wherein
when quadrature amplitude modulation levels of the first quadrature amplitude modulation codebook and the second quadrature amplitude modulation codebook are equal to 2, the first threshold is equal to 2\sqrt{5}Δ₂, wherein Δ2 is a normalized amplitude coefficient of the first quadrature amplitude modulation codebook or the second quadrature amplitude modulation codebook;
when quadrature amplitude modulation levels of the first quadrature amplitude modulation codebook and the second quadrature amplitude modulation codebook are equal to 3, the first threshold is equal to 2\sqrt{8}Δ₃, wherein Δ₃ is a normalized amplitude coefficient of the first quadrature amplitude modulation codebook or the second quadrature amplitude modulation codebook; or
when quadrature amplitude modulation levels of the first quadrature amplitude modulation codebook and the second quadrature amplitude modulation codebook are equal to 4, the first threshold is equal to 2\sqrt{17}Δ₄, wherein 44 is a normalized amplitude coefficient of the first quadrature amplitude modulation codebook or the second quadrature amplitude modulation codebook.

8. The method according to claim 7, wherein
when the quadrature amplitude modulation levels of the first quadrature amplitude modulation codebook and the second quadrature amplitude modulation codebook are equal to 2, and a quadrature amplitude modulation level of the third quadrature amplitude modulation codebook is equal to 1, the second threshold is equal to 2\sqrt{10}Δ₂;
when the quadrature amplitude modulation levels of the first quadrature amplitude modulation codebook and the second quadrature amplitude modulation codebook are equal to 3, the second threshold is equal to 2\sqrt{14}Δ₃ or 2\sqrt{71/5}Δ₃; or
when the quadrature amplitude modulation levels of the first quadrature amplitude modulation codebook and the second quadrature amplitude modulation codebook are equal to 4, the second threshold is equal to 2\sqrt{33}Δ₄ or 2\sqrt{34}Δ₄.

9. The method according to claim 2, wherein the first data is data sent for a single time or data sent for a plurality of times.

10. A communication apparatus, comprising:
a transceiver unit, configured to send, to a second device, first data modulated by using a first quadrature amplitude modulation codebook; and
the transceiver unit is further configured to: when the second device fails to decode the first data modulated by using the first quadrature amplitude modulation codebook, send, to the second device, second data modulated by using a second quadrature amplitude modulation codebook, wherein the second data is a subset of the first data, and the first quadrature amplitude modulation codebook is different from the second quadrature amplitude modulation codebook.

11. The apparatus according to claim 10, wherein
a minimum distance between constellation points in a two-dimensional constellation diagram formed by the first quadrature amplitude modulation codebook and the second quadrature amplitude modulation codebook is greater than or equal to a first threshold.

12. The apparatus according to claim 10, wherein the transceiver unit is further configured to:
when the second device fails to jointly decode the first data and the second data, send, to the second device, third data modulated by using a third quadrature amplitude modulation codebook, wherein the third data is a subset of the first data.

13. The apparatus according to claim 12, wherein
at least one of the first quadrature amplitude modulation codebook and the second quadrature amplitude modulation codebook is different from the third quadrature amplitude modulation codebook.

14. The apparatus according to claim 12, wherein
a minimum distance between constellation points in a three-dimensional constellation diagram formed by the first quadrature amplitude modulation codebook, the second quadrature amplitude modulation codebook, and the third quadrature amplitude modulation codebook is greater than or equal to a second threshold, wherein the second threshold is greater than the first threshold.

15. The apparatus according to claim 12, wherein
when quadrature amplitude modulation levels of the first quadrature amplitude modulation codebook and the second quadrature amplitude modulation codebook are equal to 2, the first threshold is equal to 2\sqrt{5}Δ₂, wherein Δ₂ is a normalized amplitude coefficient of the first quadrature amplitude modulation codebook or the second quadrature amplitude modulation codebook;
when quadrature amplitude modulation levels of the first quadrature amplitude modulation codebook and the second quadrature amplitude modulation codebook are equal to 3, the first threshold is equal to 2\sqrt{8}Δ₃, wherein Δ₃ is a normalized amplitude coefficient of the first quadrature amplitude modulation codebook or the second quadrature amplitude modulation codebook; or
when quadrature amplitude modulation levels of the first quadrature amplitude modulation codebook and the second quadrature amplitude modulation codebook are equal to 4, the first threshold is equal to 2\sqrt{17}Δ₄, wherein Δ₄ is a normalized amplitude coefficient of the first quadrature amplitude modulation codebook or the second quadrature amplitude modulation codebook.

16. The apparatus according to claim 15, wherein
when the quadrature amplitude modulation levels of the first quadrature amplitude modulation codebook and the second quadrature amplitude modulation codebook are equal to 2, and a quadrature amplitude modulation level of the third quadrature amplitude modulation codebook is equal to 1, the second threshold is equal to 2\sqrt{10}Δ₂;
when the quadrature amplitude modulation levels of the first quadrature amplitude modulation codebook and the second quadrature amplitude modulation codebook are equal to 3, the second threshold is equal to 2\sqrt{14}Δ₃ or 2\sqrt{71/5}Δ₃; or
when the quadrature amplitude modulation levels of the first quadrature amplitude modulation codebook and the second quadrature amplitude modulation codebook are equal to 4, the second threshold is equal to 2\sqrt{33}Δ₄ or 2\sqrt{34}Δ₄.

17. The apparatus according to claim 10, wherein
the first data is data sent for a single time or data sent for a plurality of times.
